(19) United States
(12) Patent Application Publication
(10) Pub. No.: US 2004/0131350 A1
(43) Pub. Date: Jul. 8, 2004

(54) Photographic film cartridge and camera including such

(76) Inventor: Ching Miao Wilson Wang, Hong Kong (HK)

Correspondence Address: KAPLAN & GILMAN , L.L.P., 900 ROUTE 9 NORTH, WOODBRIDGE, NJ, 07095, US

(21) Appl. No.: 10/724,944

(22) Filed: Dec. 1, 2003

Related U.S. Application Data
(63) Continuation-in-part of application No. 10/124,718, filed on Apr. 17, 2002.

(30) Foreign Application Priority Data
Nov. 2, 2001 (NZ) 515259

(51) Int. Cl. G03B 17/26

(52) U.S. Cl. 396/513

(57) ABSTRACT

A camera comprises a camera body with a lens and shutter operating control and film cartridge removable from the camera body having an unexposed film spool region and an exposed film spool region and a bridging portion between those regions. An opening in the cartridge permits light from the lens to pass through the opening to the film at the bridging portion. A door closes the opening of the cartridge and the door is openable with the cartridge installed in or attached to the camera body. Cooperating elements on the ca amera body and the cartridge open the door or close the door with the door being openable when the cartridge is fully engaged with the camera body. There is a detented connection of the film cartridge in the camera body.

### RELATED PATENT APPLICATION

This application claims priority to U.S. patent application Ser. No. 10/083,331, filed on Feb. 25, 2002, and to U.S. patent application Ser. No. 10/124,718, filed Apr. 17, 2002, which is itself a Continuation-in-part of the '331 patent application. The entire disclosures of the two patent applications are hereby incorporated by reference.

### FIELD OF INVENTION

The present invention relates to a photographic film cartridge and camera including the cartridge and in particular although not solely of a kind to provide a semi disposable use.

### BACKGROUND OF THE INVENTION

Nowadays, commonly used photographic films include 135 films, 120 films, 110 films and APS films, among which 135 films are the most popular films. 120 films are mainly used for commercial purposes because of their high quality and larger sizes. The size of 110 films is relatively small and its quality is relatively low, so it is not very popular. APS is a new technology and has a lot of advanced features, however, its film development system is not compatible with 135's, so the growth of APS has been restricted.

The development of disposable cameras has been comparatively fast. There are many advantages in that they are easy to operate, low in cost, easy to carry and the quality is acceptable. Disposable cameras are particularly suitable for beginners. Since the procedures of inserting and removing the film involves some degree of knowledge and skill, the current disposable camera avoids the possibility of errors as far as loading of films is concerned because the film is pre-loaded.

There are two main disadvantages of disposable cameras. The cost of buying the camera includes both the camera set and the film set, but the camera set is disposed of after a single use although some of them may be recycled. This creates waste. Secondly, being a disposable item in nature, there is tight control on the production cost which therefore restricts the inclusion of more advanced features such as auto flash, auto wind and higher quality lens.

People have been trying to develop a product which can produce good quality photos like an ordinary 135 film camera but at the price of and with simplicity of operations of a disposable camera.

A combination camera body with features such as the lens, shutter, dark room and film winder which was capable of receiving a replaceable film cartridge has been available to the public before. The cartridge for use with the camera body came in the form of two film spooling regions, a first spooling region where the film was spooled in an unused state and a second spooling region to which the film was advanced after having been exposed. The two spooling regions were interconnected by a bridging portion wherein the bridging portion held the film in a position relative to the lens and shutter to allow exposure of each frame of the film. The spooling regions were effectively light sealed regions such that any film within the spooling regions could not be exposed to light. The film extending across the bridging region was able to be exposed to light and, when in use, such light was controlled by the lens and shutter arrangement of the camera body. The cartridge, outside of the camera body, did not provide any dark room effect to the film between the two spooling regions. Hence the use of cameras of this type required the film to be inserted into the camera body and remain within the body during the stages where the film was advanced from one spooling region to another, if no undesirable exposure of the film was to occur as a result of the cartridge being removed from the camera body and thereby allowing any films extending across the bridging region to be exposed. Such earlier designs hence did not lend themselves to allowing for film cartridges to be removed midway during use of the film without risking detrimental exposure of the film extending between the two spooling regions. Earlier type of design also required separate apparatus for processing the film in terms of handling the film from the cartridge after it had been used. Since the predominant format of film now is the 35 mm format and indeed the earlier film types in the cartridges such as the 110 format are now very uncommon, most development labs are set up for developing the 35 mm format or the APS format. Any introduction of a new format may mean that further handling equipment will need to be purchased by development labs to which there will be resistance. It would hence be desirable for a film cartridge to exist which includes a standard 35 mm film incorporated with a film canister which will make the subsequent handling of the film for development by development labs convenient.

It is accordingly an object of the invention to provide a photographic film cartridge which may be used with a camera body which provides greater flexibility and convenience of use or which will at least provide the public with a useful choice.

It is a further object to provide a camera body and film cartridge combination set which provides greater flexibility and convenience of use or which will at least provide the public with a useful choice.

It is a further object to provide a camera with a film cartridge removable and exchangeable without undesirable exposing of the film therein.

It is a further object of the present invention to provide a film cartridge which includes a preloaded film engaged for scrolling to and/or from a standard 35 mm or APS film canister.

### SUMMARY OF THE INVENTION

Accordingly, a first aspect of the camera according to the present invention broadly comprises a photographic film cartridge forming a dark room for accommodating a film, and a camera body having a receptacle for removably and snugly accepting the cartridge therein. The cartridge is provided with an opening which remains closed when the cartridge is removed from the receptacle, and is openable for exposing the film to a light control device to form an image on the film when the cartridge is accepted in the receptacle.

A door is provided to be selectively movable between a first position to close the opening and a second position to open the opening. Preferably the door is forced to remain at the first position by a spring and kept there by a locking latch when the cartridge is outside the camera body. Preferably the locking latch is unlocked and the door is moved to the second position upon insertion of the cartridge into the receptacle.

Thus, the cartridge can be removed from the camera body anytime without exposing the film therein. This is very helpful when a user wants to change different types of film to suit different uses (e.g. different ASA) or the grouping of photos of a particular nature in a particular roll of film/film set (e.g. different occasions, different groups of people, different subject matters etc). Interchangeability of camera bodies for one film cartridge can also be achieved with the present invention. A camera body which provides particular features such as a wide angled lens, a colored lens or other effect type lens may be provided, where the film cartridge of the present invention is interchangeable between such bodies.

A second aspect of the present invention broadly comprises a film cartridge containing a film for engagement with a camera body to thereby in combination allow the capturing of an image onto the film in reliance on appropriately provided and positioned light control and projection means of said camera body to selectively allow light to be projected onto a portion of the film in said cartridge to thereby be exposed by said light. The film cartridge comprises: an unexposed film spool region, a second spool region, and a bridging portion between the unexposed film spool region and the second spool region via which the film can be advanced to at least in part be moved from the unexposed film spool region to the second region. The bridging region provides a dark room for the film between the unexposed film spool region and the second spool region. The bridging region includes an opening positioned such that when the film cartridge is engaged with the camera body, film is presented for exposure by light admitted through the light control means of the camera body and the opening of the film cartridge.

A door is provided to the film cartridge to selectively move between a first and second position. In the first position, the cartridge opening is closed to prevent light from entering the dark room. In the second condition, the opening is open to allow exposure of the film.

A third aspect of the present invention broadly comprises a camera having a camera body and a film cartridge containing a film, in engagement with the camera body to thereby in combination allow the capture of an image onto the film in reliance on appropriately provided and positioned light control and projection means of the camera body to selectively allow light to be projected onto a portion of the film in the cartridge to thereby be exposed to light.

The film cartridge comprises: an unexposed film spool region, a second spool region and a bridging portion between the unexposed film spool region and the second spool region via which the film can be advanced to at least in part be moved from the unexposed film spool region to the second region.

The bridging region provides a dark room for the film between the unexposed film spool region and the second spool region. The bridging region includes an opening positioned such that when the film cartridge is engaged with the camera body, film is presented for exposure to light admitted through the light control means of the camera body and the opening of the film cartridge.

A door is provided to the film cartridge to selectively move between a first and second position. In the first position, the opening is closed to prevent light from entering the dark room and in the second condition, the opening is open to allow exposure of the film. The door is preferably maintained in the first position until the cartridge is fully engaged in the camera body.

Preferably, when in a fully engaged condition, the camera body and the cartridge cooperate to define a region which is light sealed except when the light control means is activated to expose part of the film in the bridging portion.

The door is preferably actuated to move between the first and second positions by an actuation means of the camera body. The actuation mans preferably engages a safety latch for the door to trigger the movement of the door from the first position to the second position.

Preferably the safety latch is provided to prevent the door from being accidentally opened when the cartridge is not in the camera body.

A spring is preferably used to move the door from the first position to the second position. The door is preferably pivotably engaged to said bridging region or is translatably engaged to said bridging region.

The actuation means preferably engages a safety latch for the door to trigger the movement of the door from the second position to the first position. A spring is preferably used to move the door from the second position to the first position. The actuation means preferably becomes operable to move the door upon the action of insertion and removal of the cartridge with the camera body.

The actuation means is preferably operable by the action of the user once the cartridge is fully engaged with the camera body. The actuation means is preferably operable upon depression of the camera body shutter control button.

Film provided inside the cartridge is engaged to a film canister, preferably of a standard 35 mm format. The film canister is preferably located at the unexposed film spool region of the cartridge such that during advancement of the film for exposure, the film is at least in part transferred from the canister to the second spool region. The film canister may preferably be located at the second spool region of the cartridge such that during advancement of the film for exposure, the film is transferred from the second spool region to the canister. The film cartridge is preferably provided for use in a condition wherein the unexposed film is in a substantial part spooled in the unexposed spool region and wherein the film extends to a distal end thereof engaged to the film canister located in the second spool region.

A further aspect of the present invention comprises a camera body for use in combination with a film cartridge as hereinbefore described. A further aspect comprises a camera body and at least one film cartridge as hereinbefore described provided in a marketable pack suitable for retail.

Yet another aspect of the present invention broadly consists in a camera or a film cartridge for use to define a camera having a control unit with which the cartridge can, in engagement with the control unit in combination, allow capture of an image onto the film in reliance on appropriately provided and positioned shutter and projection means of the cartridge, to selectively allow light to be projected onto a portion of the film in the cartridge to thereby be exposed by the light, wherein the control unit provides at least one of a trigger for activating the movement of the shutter, a flash, a film winder, a view finder, a film counter.

The film cartridge comprises: an unexposed film spool region, a second spool region and a bridging portion between the unexposed film spool region and the second spool region via which film can be advanced to at least in part be moved from the unexposed film spool region to the second region.

The bridging region provides a dark room for the film between the unexposed film spool region and the second spool region. The bridging region includes a light aperture and shutter and projection means (e.g. a lens) positioned such that when the film cartridge is engaged with the control unit, film is presented for exposure by light selectively admitted through the aperture.

A further aspect of the present invention comprises a film cartridge containing a film of an elongate kind having a first distal end and a second distal end engaged to a spooling spindle within a film canister, the cartridge being engageable with a camera body to thereby in combination allow the capturing of images onto the film in reliance on appropriately provided and positioned light control and projection means of the camera body, which selectively allow light to be projected onto a portion of the film in said cartridge. The film cartridge comprises: an unexposed film spool region, a second spool region within which the film canister is retained and a bridging portion between the unexposed film spool region and the second spool region via which the film can be advanced to at least in part be moved from the unexposed film spool region to the second region.

The bridging region provides a dark room for the film extending between the unexposed film spool region and the second spool region, when the film cartridge is engaged to the camera body. The bridging region includes an opening positioned such that when the film cartridge is engaged with the camera body, that portion of the film in the dark room is presented for exposure to light admitted through the light control means of the camera body and the opening of the film cartridge.

The film cartridge prevents light from entering the unexposed spool. The film cartridge is preferably a housing within which the film is located and sealed from exposure to light save for that portion of the film in the dark room.

The bridging region is preferably an enclosure which includes the opening. The enclosure is preferably also open to the second spool region. The unexposed spool region is preferably enclosed except for a narrow slot through which the film can pass, such that the film in the unexposed film spool region is substantially sealed against light. The second spool region preferably includes means for driving the spooling spindle externally of the film cartridge.

The cartridge may be of one piece. But in an alternate embodiment, it is separable into one part with one of the spool regions and another part with the rest of the cartridge. The parts are detachably latchable together. This facilitates removal of film from the one part and also permits easy installation of a new film supply into the one part, which may then be transferred back to the other spool region. From the other spool region, the film can be returned to the first spool region, this time exposing the film to the images in succession.

The housing of the camera body is preferably a two part housing having a front and rear part separably engaged to each other. The rear part is preferably a lid separably engaged to the front part.

The housing detents the cartridge in the camera body. As the camera body has a receptacle with an opening into it, the photographic film cartridge is installed in the receptacle. It is guided into position by a cooperating protrusion into groove connectors.

Once the cartridge is fully installed, detent tabs on the camera body snap into recesses in the rear of the cartridge and retain the cartridge. To release the cartridge a release device moves the tabs off the cartridge. It may comprise a lever or bar which is shifted to raise the tabs. A switch operates the lever or bar to release the cartridge.

This invention may also be said broadly to consist of the parts, elements and features referred to or indicated in this specification, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

FIG. 1 shows a camera body and cartridge film prior to it being engaged with the body.

FIG. 2 is a perspective view of the film cartridge inserted in the camera body.

FIG. 3 is the film cartridge with the backing plate of the cartridge and the film removed.

FIG. 4 is the same drawing as FIG. 3 but with film added.

FIG. 5 is a perspective view of the front of the film cartridge showing the window and various operating features.

FIG. 6 shows the fully assembled film cartridge.

FIG. 6(a) is an exploded perspective view of an embodiment of the film cartridge.

FIG. 7 shows the partial insertion of the film cartridge into the camera body and shows the operation of the film cartridge door.

FIG. 8 shows the camera body from underneath showing the features that operate the film cartridge door. FIGS. 8(a), 8(b) and 8(c) respectively illustrate three stages in the operation of the film cartridge door. FIGS. 8(d), 8(e) and 8(f) are respectively perspective side and front views of a safety lock for the cartridge door. FIG. 8(g) shows the cartridge and the door separated from each other.

FIGS. 9(a) and 9(b) show the bottom and top of the camera and film cartridge respectively and illustrate some of the film advancement and control features.

FIGS. 9(c)-9(f) is a top perspective views showing the interlock engagement between the counterpart elements of the cartridge and the camera body.

FIG. 10(a) shows a bottom view of a camera body and film cartridge illustrating how they are indexed into their relative positions.

FIG. 10(b) shows a camera body and film cartridge assembled together viewed from the bottom showing the means with which the photographs remaining on the film are counted.

FIG. 10(c) shows the engagement between the counter and the bottom sprocket.

FIG. 10(d) shows the activation mechanism for the rotation of the counter shown in FIG. 10(c).

FIGS. 11(a) to 11(c) show the insertion of the film cartridge into the camera and in doing so the opening of the film cartridge door.

FIG. 12(a) and FIG. 12(b) show an alternative embodiment for the opening of the film cartridge door as the film cartridge is inserted into the camera body.

FIG. 13(a) and FIG. 13(b) illustrate a method where the camera shutter is actuated to thus exposing the film.

FIG. 14(a) and FIG. 14(b) show an embodiment where the door for opening the dark room is part of the film cartridge but actuated by an actuator means of the camera body.

FIG. 15 shows an embodiment where the film cartridge is slid up and into the camera body.

FIG. 16 shows an alternative film cartridge insertion embodiment whereby the film cartridge is inserted from the back of the camera body.

FIG. 17 shows a further alternative embodiment of the invention whereby the film cartridge comprises body of the camera including the camera shutter mechanism and a top section which comprises the control means and also the viewing and flash means.

FIG. 18 show a different embodiment of the film cartridge of the present invention where no door is provided to light seal the dark room of the bridging portion.

FIG. 19(a) is a cross sectioned view of an alternative cartridge design, viewed in the direction of arrows 19 in FIG. 19(b).

FIG. 19(b) is a front view of the alternative cartridge design.

FIG. 19(c) is a bottom view of the alternate cartridge.

FIGS. 20(a)-(d) are perspective views of the cartridge of another embodiment.

FIG. 20(e) is the exploded view of the cartridge as shown in FIGS. 20(a)-(d).

FIG. 21 illustrates the film loading process for loading the film to the cartridge shown in FIGS. 20(a)-(e).

FIG. 22 is a rear perspective view of the camera with the backing plate removed.

FIG. 23 is a rear view of an alternate for the arrangement for the camera body.

FIG. 24(a) is a perspective view showing the camera body and the film cartridge assembled together, with a self-locking mechanism.

FIG. 24(b) is a perspective view showing the separated camera body and the film cartridge of FIG. 24(a).

FIGS. 25(a) and 25(b) are enlarged partial views showing the self-locking mechanism in FIGS. 24(a) and 24(b) in locking and release positions, respectively.

FIGS. 26(a) amd 26(b) are sectional partial views showing the self-locking mechanism in FIGS. 25(a) and 25(b) in locking and release positions, respectively.

### DETAILED DESCRIPTION OF THE PREFERRED EMBODIMENTS

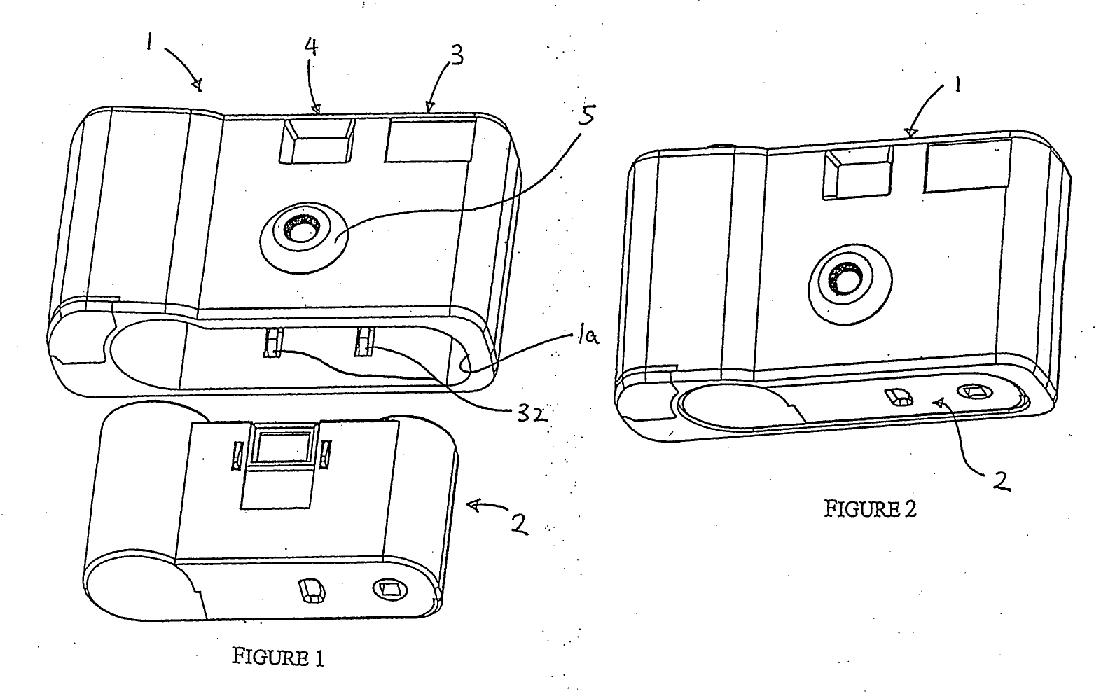

FIG. 1 illustrates a camera body 1 and a film cartridge 2. The camera body 1 is provided with a receptacle 1a having a shape complementary with the contour of the cartridge 1, thus being able to snugly accept the cartridge 1 which in this view is inserted into the camera body 1 from below. On the front of the camera body there is a view finder 4, a camera flash 3 and a light control means, typically a camera lens 5. A pair of spring leaves or spring loaded arms 32 bear against the back of the film cartridge 2, preferably engage with corresponding grooves 34 (FIG. 5) formed in the back of the film cartridge 2, to locate the cartridge in position. A camera with flash function and auto winding function will also include electric circuits for the flash light and the motor, a battery slot and a gear system.

FIG. 2 shows the fully assembled camera comprising the camera body 1 and the film cartridge 2 which has been inserted from below and locked into position. Preferably, the bottom surface of the cartridge 2 is flush with that of the camera body 1 when the cartridge 2 is fully accepted in the receptacle 1a of the camera body 1.

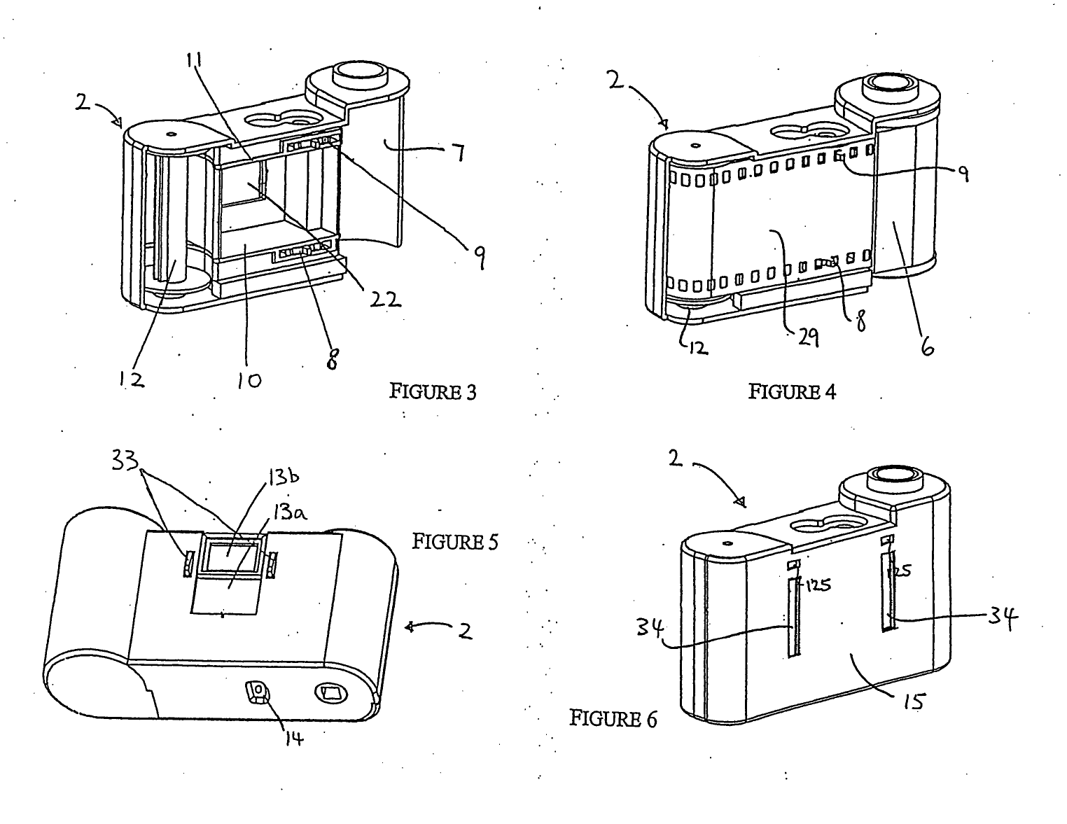

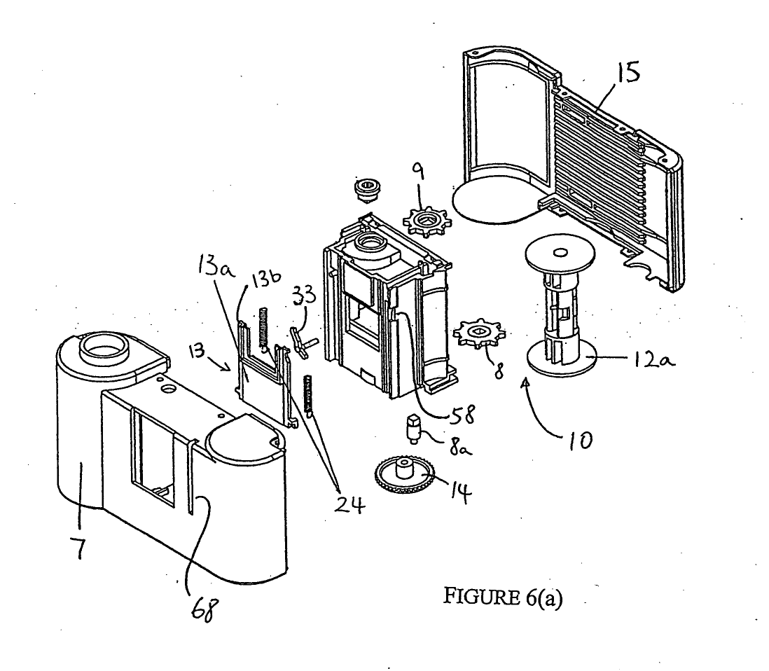

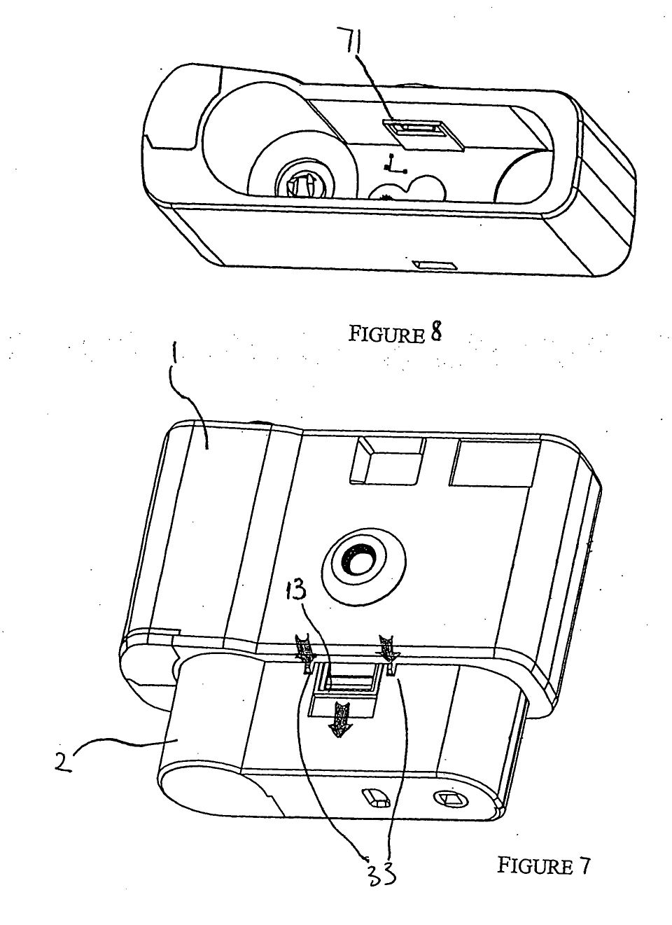

FIGS. 3 and 6(a) show the disassembled film cartridge 2 with the back plate removed and the film removed. The film cartridge internals comprise a region 7 for exposed film and advancing sprockets 8 and 9 at the top and bottom respectively of the film cartridge to positively engage the film at its periphery. A film supporting structure 11 runs around the periphery of the dark room 10, which together with the backing plate 15 and a film cartridge door 13 provides a light proof chamber for the film inside the cartridge. A spool 12a contained within the body of the film cartridge 2 allows the winding on of a section of film into the dark room and subsequent exposure for an image to be captured.

FIG. 4 shows the film 29 that has been loaded into the film cartridge 2. The film, from the unexposed film spooling region 12, is passed through the dark room, is engaged with the advance sprockets 8 and 9 and is collected by the film collection spool 6. The film in the film cartridge is for example a standard 35 mm film scroll that is loaded in to the film cartridge by the factory. In this way the user does not have to consider handling, exposure and contamination issues of the film. The rolling structure of the camera body is attached to the sprockets 8 and 9 of the film cartridge and it rolls the film back to the used film spool region which for example includes the film canister. The canister is for example a standard container for 35 mm films and therefore allows the film to be processed normally by any camera shop after the film is removed from the film cartridge. The advancement of the film may however be the other way around where it is dispensed from the canister as opposed to collected therein.

The region of the cartridge where the film extends across the dark room requires control of the light such that when the cartridge is not engaged with the camera body, any film extending across the dark room is not undesirably exposed. However, at the same time, the dark room does require light to be accessible into the dark room when the cartridge is engaged with the camera body for taking a photograph. The dark room 10 has a light opening or film cartridge aperture 22 which allows for such light as controlled by the shutter of the camera body, to expose that portion of the film in the dark room. The film cartridge aperture however is preferably closed when the cartridge is not engaged with the camera body. This closure is preferably achieved by a film cartridge door 13. FIG. 5 shows the film cartridge door 13 which comprises two portions, the first portion 13a being light impermeable and the second portion 13b being U-shaped to form an opening through which light may permeate. The film cartridge door 13 is in a condition to prevent light from entering the dark room through the film cartridge aperture 22 at least during times when the cartridge is not fully engaged with the camera body.

FIG. 5 shows one embodiment of the film cartridge 2 wherein safety releases or locks 33 prevent the movement of the film cartridge door 13 unless it is correctly engaged with the camera body. In this particular embodiment the insertion of the film cartridge 2 into the film body 1 activates the safety locks 33 to allow the film cartridge door to be opened as illustrated in FIG. 7. The location of the film cartridge by insertion also then opens the film cartridge door 13, thereby placing the film cartridge in a state ready for exposure by the camera body shutter mechanism to expose the film on demand by the user and thus create an exposure on the film of the image captured.

FIG. 6 shows the fully assembled film cartridge 2 with the backing plate 15 attached whereby the film inside is safely guarded against any light penetrating and thus pre-exposing the film. The film cartridge is therefore ready for use by insertion into, or association with, the camera.

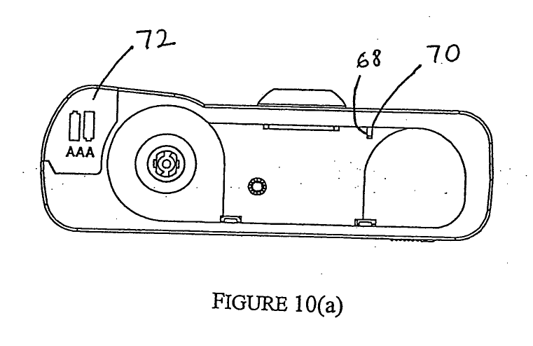

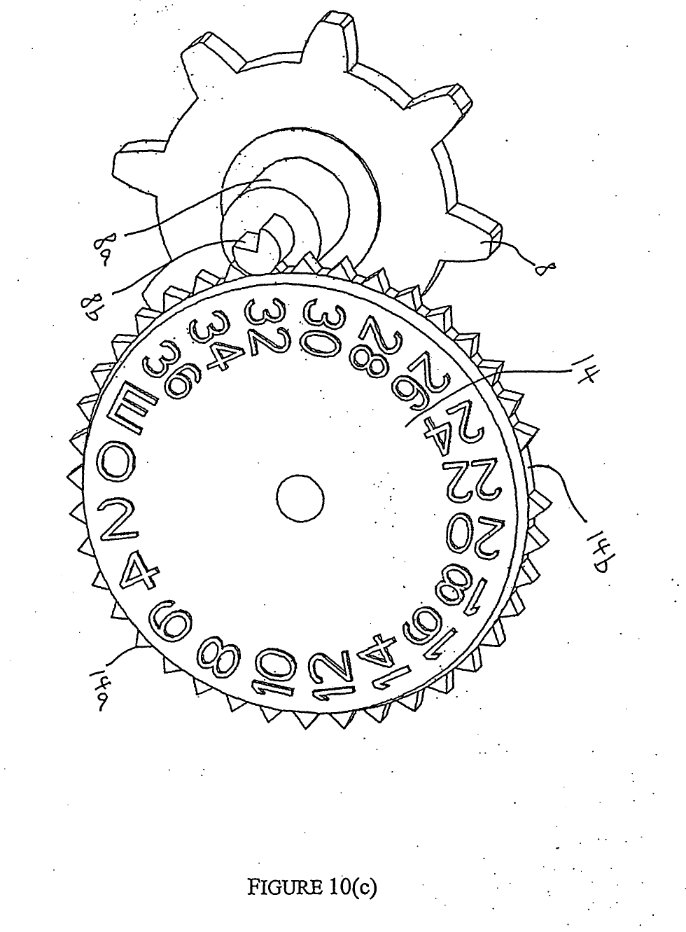

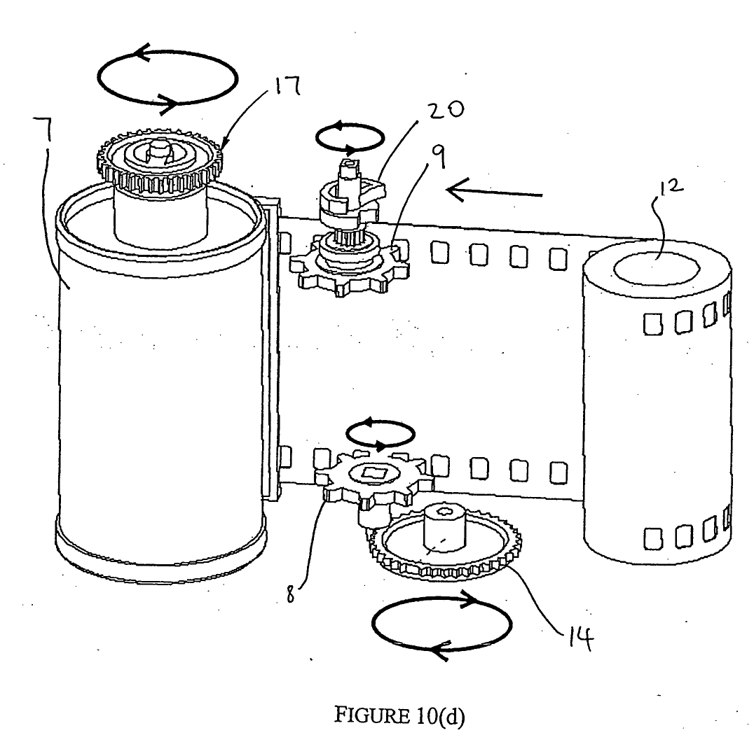

To direct the cartridge into a precise location in the camera body, the cartridge has an index or guide groove 68 seen in FIG. 6(a). As seen in FIG. 10(a), the camera body interior wall has an elongate web or protrusion 70 shaped to be received in the groove 68 only when the cartridge is properly aligned in the camera body, and the cooperating groove 68 and protrusion 70 are in continuous engagement to properly position the cartridge when installed. A camera operating component power supply, here electric battery 72, may also be in the cartridge and, through appropriate contacts in the cartridge and camera, powers the camera systems.

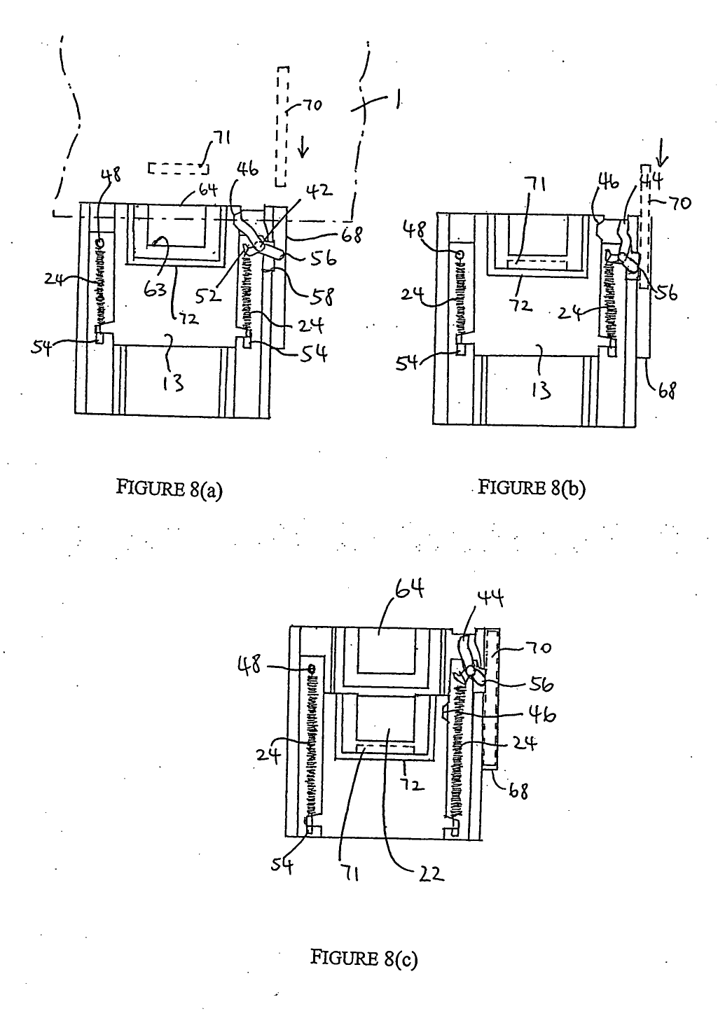

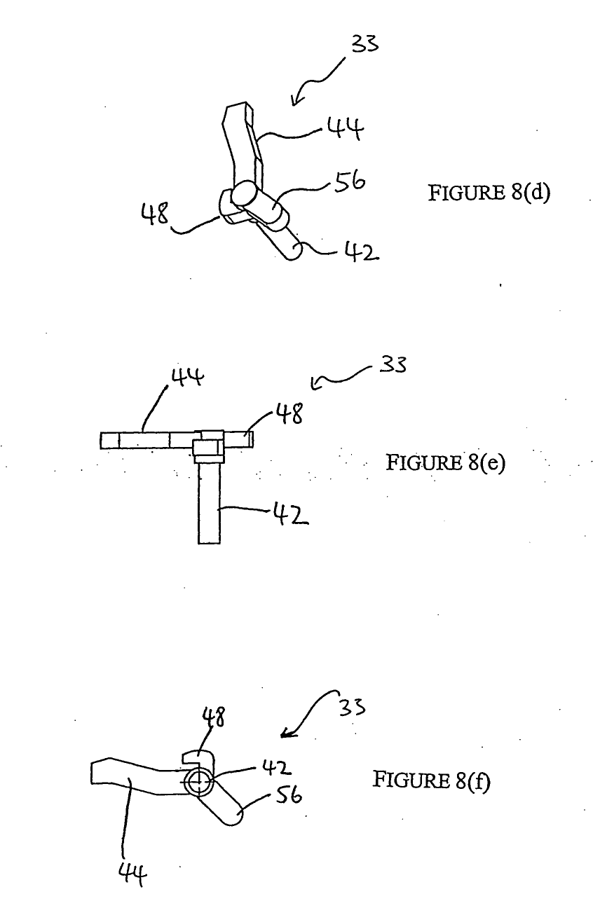

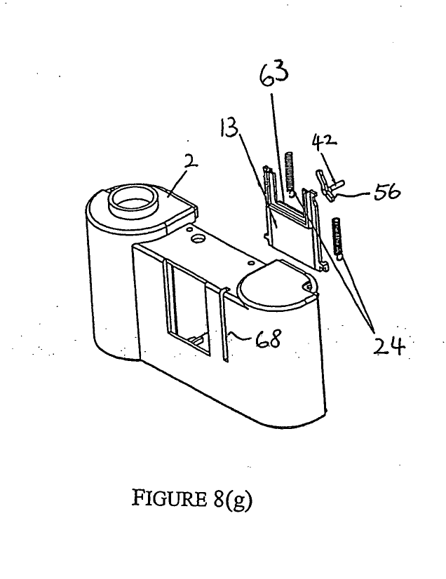

In FIG. 7 the safety locks 33 are released when the film cartridge 2 is inserted into the camera body 1 by the front inside panel of the camera casing. Once these safety locks 33 have been activated, the film cartridge door 13 is then free to slide out of the way when the cartridge is safely within the camera body, by the film cartridge door moving means or activator 71 shown in FIG. 8. In this way the film cartridge (and thus the film) can safely be removed and inserted at will by the user with there being no risk of undesired exposure of the film.

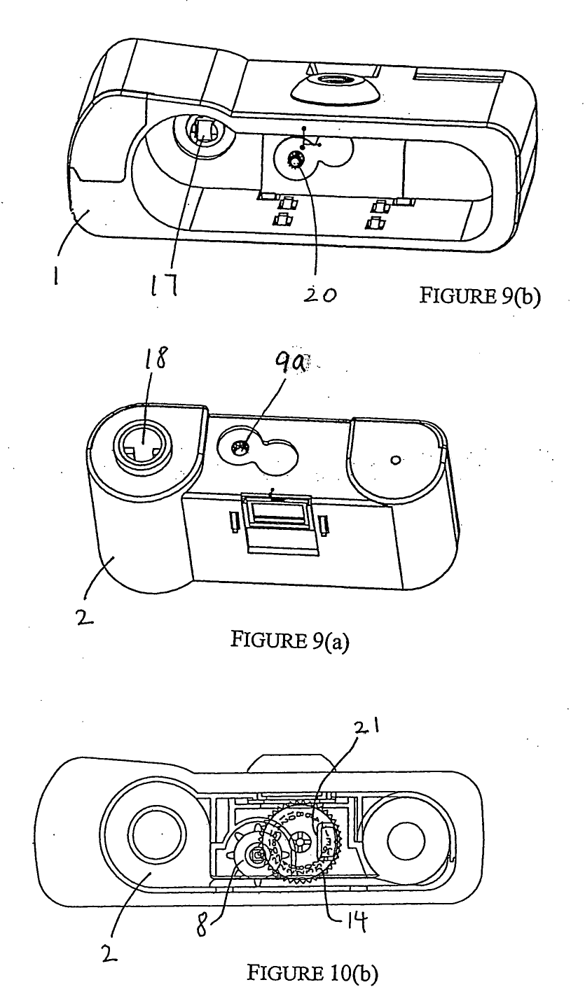

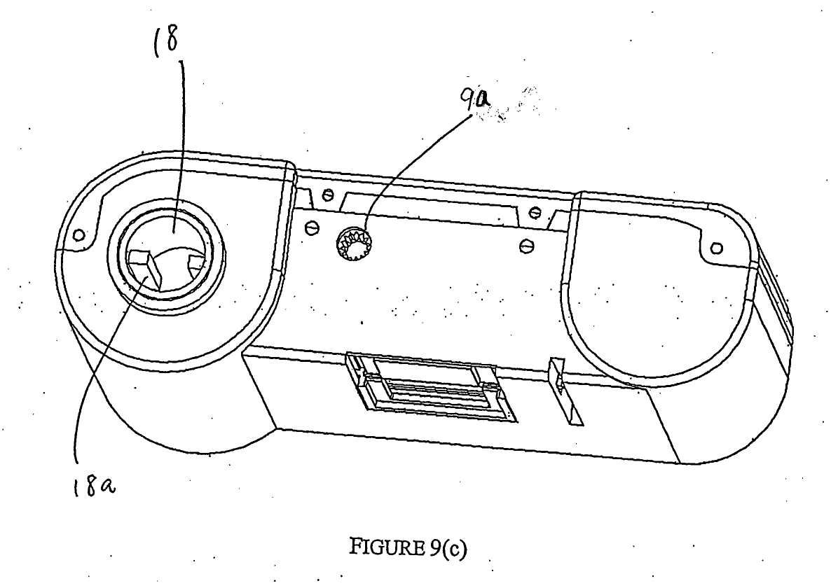

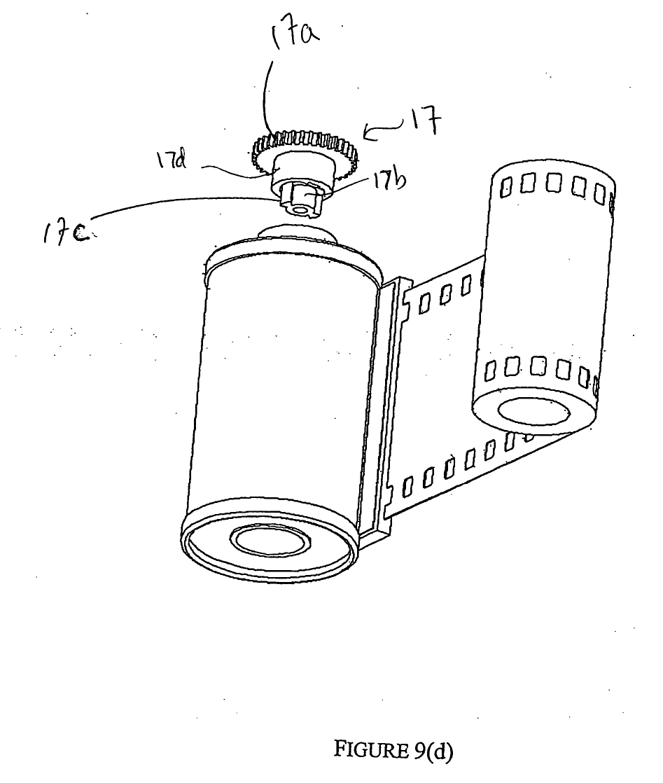

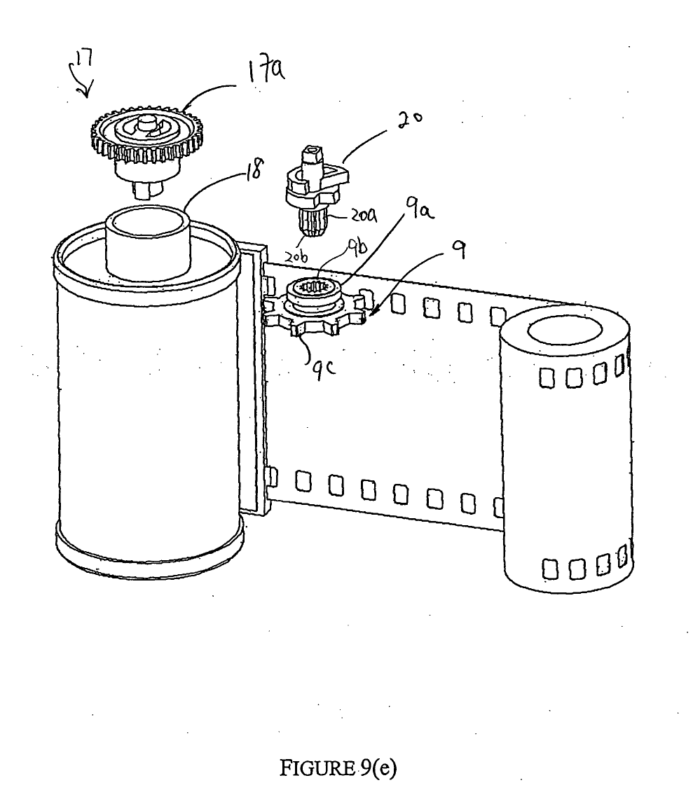

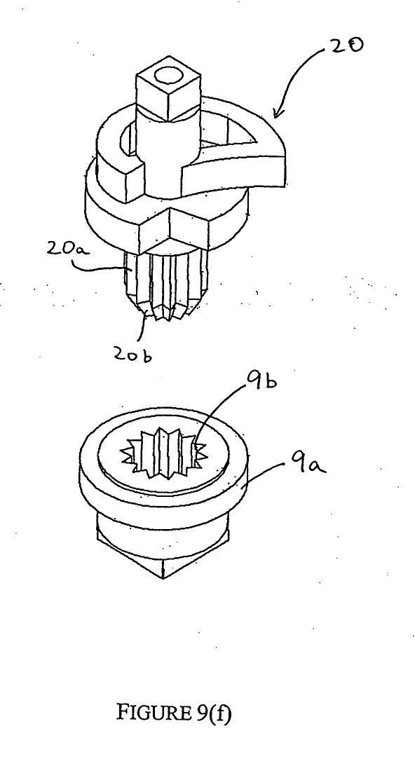

FIG. 9 shows the association of the controls within the camera body 1 in FIG. 9(b) to those mounted on top of the film cartridge 2 in FIG. 9(a). The film wind on control 17 of the camera body engages to a receiving means 18 on the collection spool 6 (FIG. 4) in the film cartridge 2. In this way, wind on of the film effected by the user on the camera body will be transmitted to the actual film in the film cartridge. The top film advance sprocket 9 has receiving means 9a associated with it to engage with an interlock control 20 in the camera body.

As illustrated in more detail in FIGS. 9c-9(d), the wind on control 17 comprises a toothed wheel 17a with a shaft 17b having a pair of longitudinal protrusions 17c formed on the peripheral surface of the shaft 17b. The receiving means 18 formed on the collection spool 6 is a cylindrical receptacle for accepting the shaft 17b therein when the cartridge 2 is inserted in the camera body 1. A pair of abutment blocks 18a is provided inside the cylindrical receptacle 18 to engage with the protrusions 17c of the shaft 17b side by side, whereby the collection spool 6 follows the rotation of the toothed wheel 17a.

When the cartridge 2 is inserted into the camera body 1, it can not be guaranteed that the protrusions 17c of the shaft 17b not to abut on the top of the blocks 18a in the receptacle 18, and if so, the cartridge 2 can not be fully accepted in the camera body 1 and the wind on control 17 can not engage with the collection spool 6 properly. To solve this problem, the shaft 17b is not directly connected with the toothed wheel 17a. Instead, the shaft 17b is accommodated in a sleeve 17d which is integrated with the toothed wheel 17a. A spring (not shown) is provided inside the sleeve 17d to bias the shaft 17b outward of the sleeve 17d, or downward as shown in the figures. When inserting the cartridge 2 into the camera body 1, if the protrusions 17c of the shaft 17b happen to abut on the top of the blocks 18a, the blocks 18a will push the shaft 17b to retreat into the sleeve 17d against the biasing spring therein, whereby the abutment of the protrusions 17c on the top of the blocks 18a will not interfere the fully insertion of the cartridge 2 into the camera body 1. After the cartridge 2 is fully accepted inside the camera body 1, rotation of the toothed wheel 17a will bring the protrusions 17c to a position offset with the blocks 18a, whereby the shaft 17b will be pushed into the receptacle 18 by the biasing spring in the sleeve 17d, and the protrusions 17c abut against the blocks 18a side by side.

As illustrated in more detail in FIGS. 9(e) and 9(f), the interlock control 20 provided on the camera body 1 engages with the top sprocket 9 provided on the cartridge 2 for advancing the exposed film toward the collection spool 6. The sprocket 9 is formed with a plural of teeth 9c equally around its periphery, which are capable of engaging with the holes provided along the upper rim of the film so as to move the film. The interlock control 20 is provided with a toothed shaft 20a which engages with the receiving means 9a of the sprocket 9. The receiving means 9a is a hollow shaft coaxial with the sprocket 9, with a toothed inner surface 9b which engages with the toothed shaft 20a after the shaft 20a is accepted therein. To facilitate the insertion of the toothed shaft 20a into the hollow shaft 9a, the toothed shaft 20a is formed with a tapered head 20b, which helps to guide the toothed shaft 20a into the hollow shaft 9a during the insertion of the cartridge 2 into the camera body 1.

The rotation of the toothed wheel 17a and the interlock control 20 follows the triggering activation of the shutter of the camera with proper interlock mechanism which also prevents the double exposure of the film. The arrangement may work whereby the means to activate the camera shutter mechanism and thus take a photograph is only enabled when the film has been wound on. In a situation where the film has not been wound on from a previous photograph having been taken, then the camera shutter mechanism activation means will not be enabled.

By engagement between the toothed shaft 20a of the interlock control 20 and the hollow shaft 9b, each time when a photo is taken, the sprocket 9 is activated to rotate an angle, and the teeth 9c drive the film to advance a frame from the unexposed spooling region 12 to the exposed spooling region 7.

The film counter 14 as shown in FIG. 10(b), which records the number of photographs either taken or remaining on the roll of film, is visible through an aperture 21 in the base of the film cartridge 2, as shown in FIG. 5. As most clearly shown in FIGS. 10(c) and 10(d), the counter 14 is in the form of a disc with numbers thereon to indicate the number of photos that have been taken, or to indicate the number of frames of the film that have not be used. Only even numbers are shown on the counter 14 in this embodiment in FIG. 10(c), and of course, odd numbers can also be used in addition to or in replacement of these even numbers.

The rotation of the counter 14 follows the rotation of the sprockets 9 and 8. More specifically, each time a photo is taken, the sprocket 9, which is interlocked with activation mechanism triggering the shutter (not shown), is activated to rotate an angle so as to advance a frame of film from the unexposed spooling region 12 to the exposed spooling region 7. The advancement of the film rotates the bottom sprocket 8 which engages with the counter 14, thus transmitting the rotation to the counter 14. By direct association with the bottom sprocket 8, the number of exposures taken and/or remaining on the film roll can be known. The direction of the rotation or movement of these related elements are shown by arrows in FIG. 10(d).

As shown in FIG. 10(c), the counter 14 is provided with teeth 14a around its peripheral, which engage with a notch 8b provided on a connection shaft 8a of the bottom sprocket 8. With the engagement between the teeth 14a and the notch 8b, the counter 14 may rotate incrementally corresponding to the advancement of each frame of the film. Because of the fact that the counter 14 is driven at its peripheral, the force applied thereon is not large, and therefore the harm to the film which drives the sprocket 8 is minimized.

It may be noted a slot 14b is provided at the peripheral of the counter 14 where there is no tooth. The position of the slot 14b corresponds to the number zero where the counter 14 will not further rotate once the slot 14b is reached. The slot 14b also helps to reset the counter 14 at the appropriate number when a new roll of film is installed.

As an alternative, the counter 14 may be concentrically connected to the shaft 8a of the sprocket 8. In such an arrangement, the peripheral teeth of the counter can be omitted, however a larger force is needed to drive the counter 14.

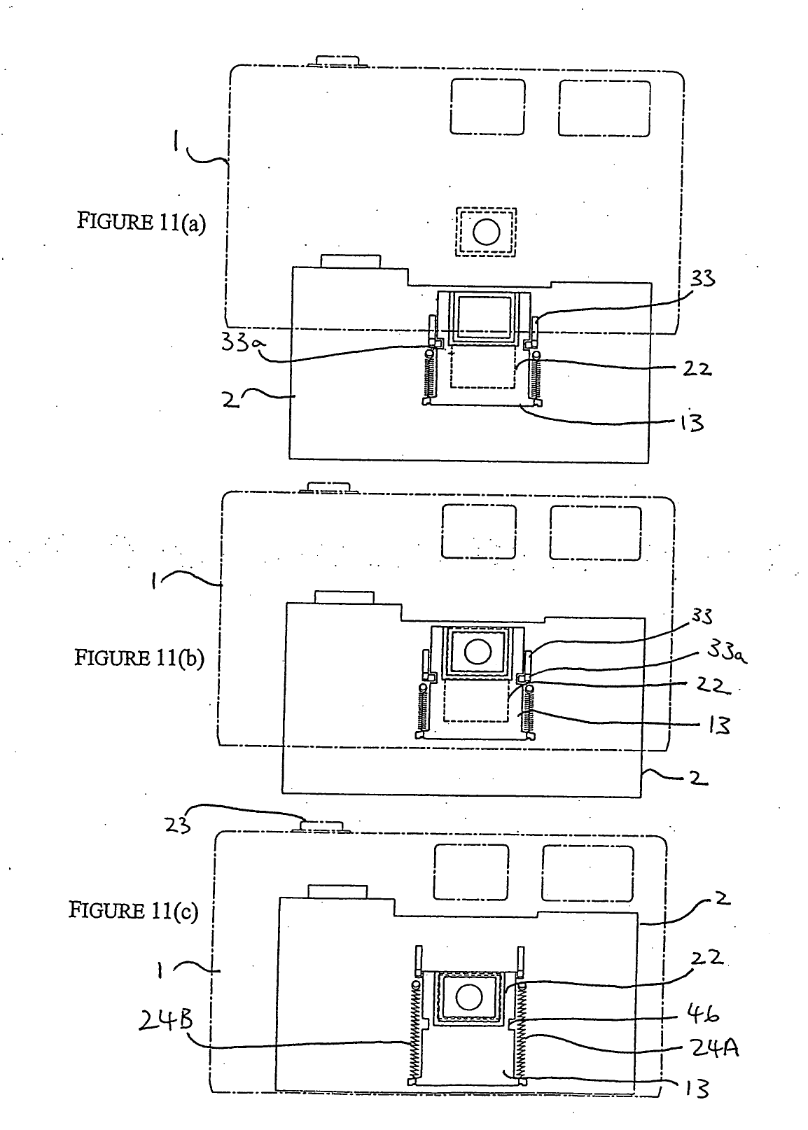

FIGS. 11 (a) (b) and (c) show, as an exemplary embodiment, a series of movements of the film cartridge door 13 by translation to progressively open the film cartridge aperture 22. The film cartridge 2 is shown in FIG. 11(a) partially inserted into the camera body 1. With its locking tab ends 33a resting in notches 46 at both sides of the door 13, the L-shaped safety lock 33 engages the cartridge door 13 holding it closed. FIG. 11(b) shows the film cartridge 2 inserted into the camera body 1 just prior to engagement of the film cartridge door 13 with means (not shown) to open the film cartridge aperture 22. Final insertion of the film cartridge 2 into the camera body 1 releases the safety lock 33, either by swinging the locking tab ends 33a outward of the receiving notches 46 in the door 13 or perhaps by breaking off the locking tab ends 33a of the safety lock 33. The insertion moves the film cartridge door 13 completely to its open position and opens the film cartridge aperture 22 thus allowing a photograph to be taken upon pressing of the shutter activation button 23. The film cartridge door 13 is normally held closed when the film cartridge is out of the camera cartridge by springs 24 (a) and (b) which attach to the film cartridge at their upper point and to the film cartridge door 13 at their lower point.

FIG. 6(a) is an exploded view showing the various components of the cartridge, including the preferred embodiment of the safety lock 33. The safety lock 33, shown in FIGS. 8(d), 8(e) and 8(f) is an integral pivotal unit including a latch arm 44 engages with a notch 46 formed on a side wall of the door 13 so as to lock the door 13 at its closed position as shown in FIG. 8(a) when the cartridge 2 is not attached to the camera body 1. The safety lock 33 comprises a latch release lever 56 extending through an opening 58 formed on the body of the cartridge adjacent the door 13 into a guide groove 68 formed parallel to the linear movement path of the door 13. The safety lock 33 is capable of rotation around a pivot shaft 42, but is biased to its locking position as shown in FIG. 8(a), e.g., by a spring (not shown). When the cartridge 2 is outside of the camera body 1 as shown in FIG. 8(a), the latch arm 44 is normally pivoted as shown in FIG. 8(a) into the notch 46. This latching holds the door 13 over the film cartridge aperture 22 (not shown in FIG. 8(a)), blocking entrance of light into the film cartridge. The top edge 63 of the door 13 abuts an abutment 64 that positions the door 13. To match the U-shaped opening 13b of the door 13, the abutment 64 is a square protrusion in shape. A hook 48 supports the upper end 52 of the drive spring 24. The lower end of the spring 24 is attached on the spring tab 54 at the bottom of the door 13.

Upon insertion of the cartridge into the camera from below, a protrusion web 70 formed on the inner wall of the camera 1 moves into the guide groove 68 and pushes the latch release lever 56 out of the groove 68, whereby the latch arm 44 is moved out of the notch 46 upon rotation of the safety lock 33 around the pivot shaft 42 (FIG. 8(b)). Upon further insertion of the cartridge 2 into the camera body 1, the door 13 is opened by an activator or protrusion abutment 71 provided inside the camera body 1 which pushes on the edge 72 of the door 13 downward against the force of springs 24. During the insertion of the cartridge 2 into the camera body 1, the protrusion web 70 keeps its occupation in the groove 68 and prevents the latch release lever 56 from entering the groove 68, thus keeping the safety lock 33 at its unlocking position.

When detaching the cartridge 2 from the camera body 1, the protrusion abutment 71 and the protrusion web 70 moves away from the cartridge 2. Upon retreat of the protrusion abutment 71, the door 13 moves from its open position shown in FIG. 8(c) towards its closed position shown in FIGS. 8(b) and 8(a) because of the biasing force of the springs 24. Upon retreat of the protrusion web 70 from the groove 68, the latch release lever 56 reenters the groove 68 to its normal position because of the biasing force from a spring member (not shown), and the latch arm 44 reengages the notch 46 of the door 13 to prevent the door 13 from being accidentally opened.

As an alternative, the springs 24 may be compression springs which by default pushes the door 13 towards its open position as shown in FIG. 8(c) if the safety lock 33 is released. In such a case, a device shall be provided to raise the door 13 against the bias of the compression spring 24 to its closed position before the cartridge 2 is removed from the camera body 1.

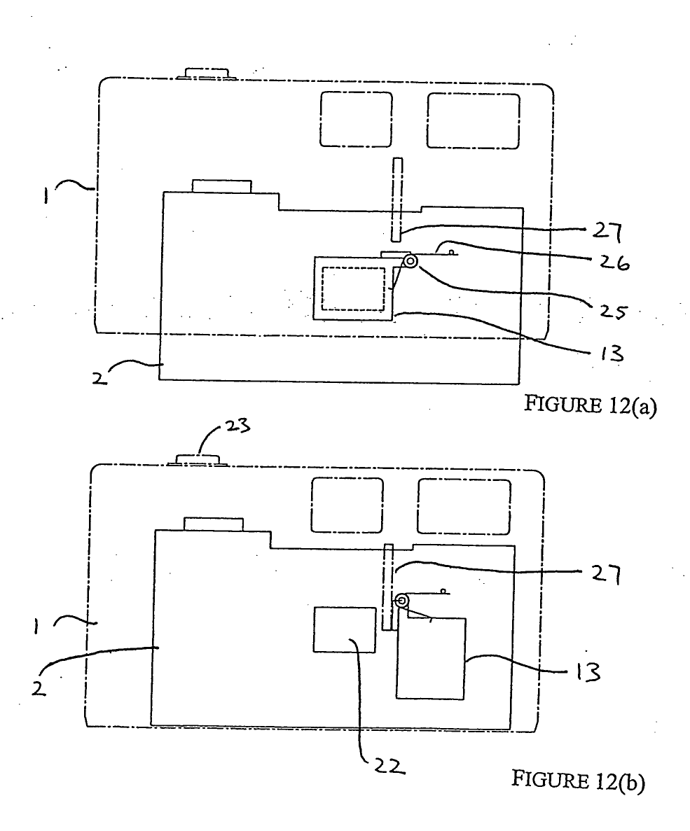

FIGS. 12(a) and (b) show an alternative means to that of FIG. 11 for opening the film cartridge door upon insertion of the film cartridge 2 into the camera body 1. FIG. 12(a) shows the film cartridge 2 partially inserted into the camera body 1. The film cartridge door 13 is rotatably supported by a pivot 25 and held in place by a spring means 26. A film cartridge door opening means 27 is located within the camera body. Upon final insertion of the film cartridge 2 into the body of the camera 1 as depicted in FIG. 12(b), the opening means 27 bears upon the film cartridge door 13 and rotates it, in this case, by for example 90 degrees, to open the film cartridge aperture 22. In this way correct operation of the camera shutter by the shutter activation button 23 will take a photograph of the viewed image.

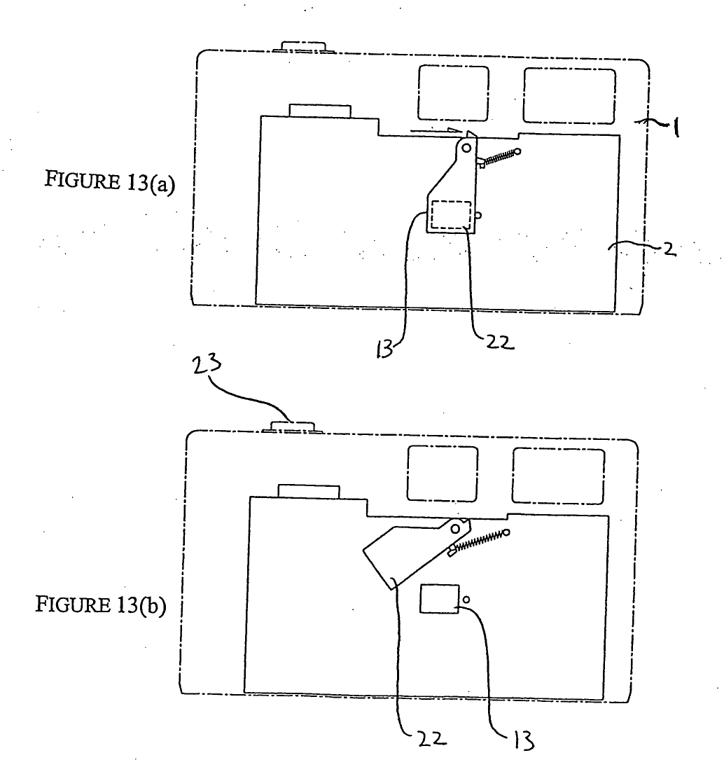

FIG. 13(a) shows a film cartridge 2 fully inserted into the camera 1 and a film cartridge door 13 covering the film cartridge aperture 22. FIG. 13(b) shows the aperture 22 uncovered by rotation of the film cartridge door 13 to the left. Here the film cartridge door 13 doubles as the camera shutter mechanism and also as the film cartridge door. The taking of a photograph by activation of the shutter button 23 activates the film cartridge door 13 (which is also the camera shutter) to rotate to one side and thus expose the film to the image.

Thus, with the cartridge door 13 also serving as the shutter of the camera, it is possible that no shutter is needed on the camera body 1.

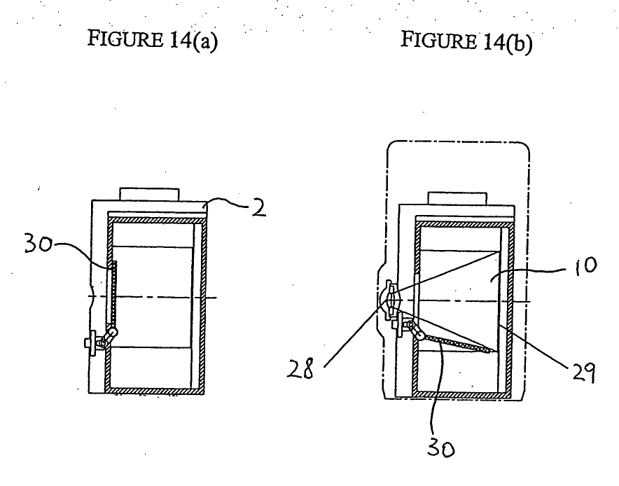

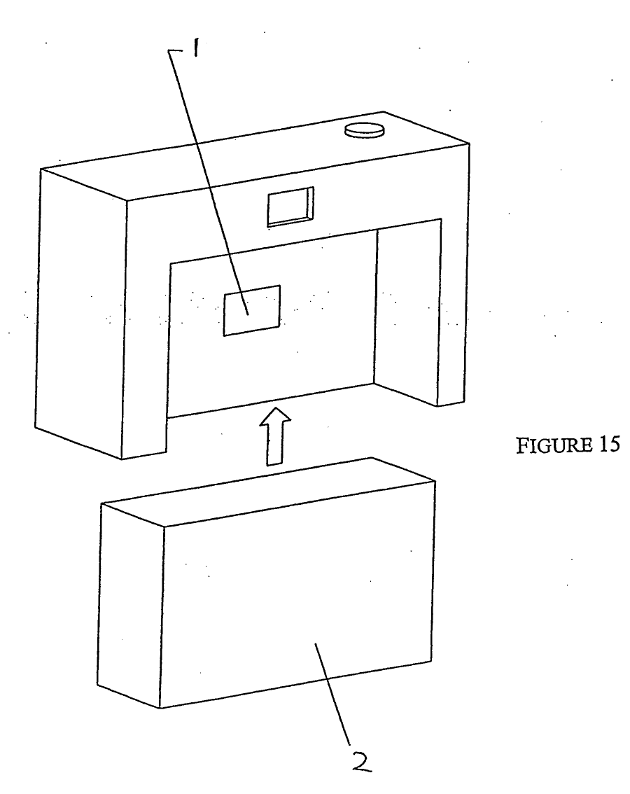

FIGS. 14(a) and (b) show an alternative means for film exposure. A cartridge door mechanism 30 in FIG. 14(a) is closed. Activation of the door is achieved by a button accessible from the exterior of the camera and the door folds into the dark room 10. Once the door is open the camera can be used at will to take photographs by the provision of the aperture, lens and shutter of the camera body.

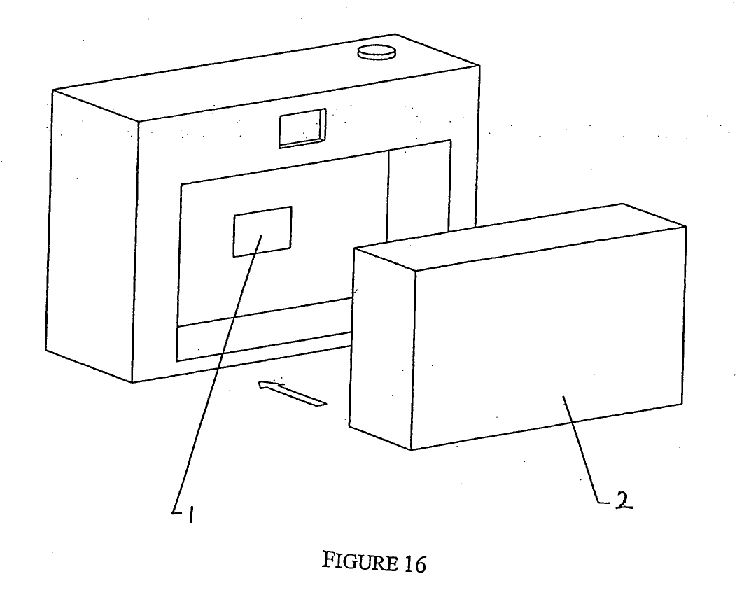

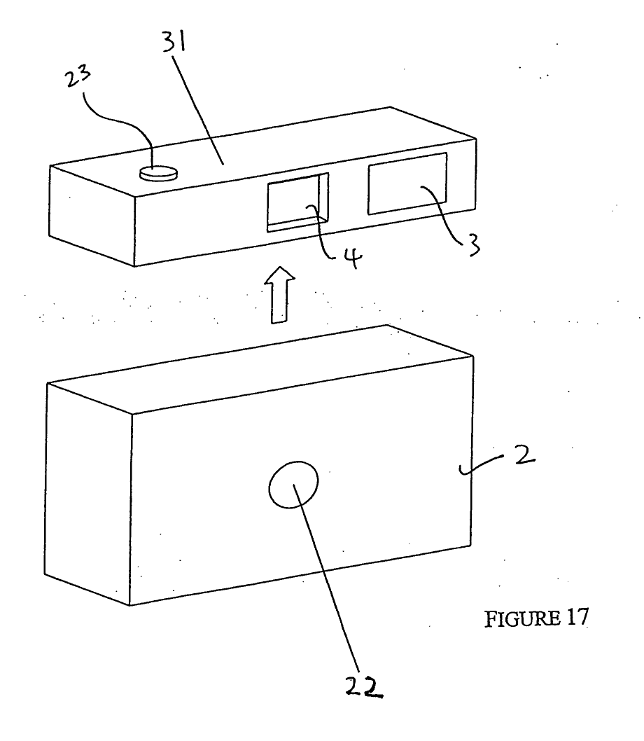

One embodiment of the camera 1 and the film cartridge 2 is shown in FIG. 15, whereby the film cartridge 2 is brought into the camera from beneath and locked into position. FIG. 16 shows an alternative embodiment whereby the film cartridge 2 is inserted into the camera 1 from the rear face of the camera 1 and locked into position. FIG. 17 shows a further alternative embodiment whereby the film cartridge 2 contains not only the film and the exposure means but also the lens and is itself a component of the camera which the user will hold onto. This combination film-cartridge-camera body is then attached to control body 31 which includes the shutter activation button 23, the viewing means 4, and the flashlight means 3 which may be electrically powered by a battery in the cartridge. In this way the camera body is reduced to the bare minimum needed to activate, control and aim the camera and the film cartridge attaches to it and is the disposable or reattachable component.

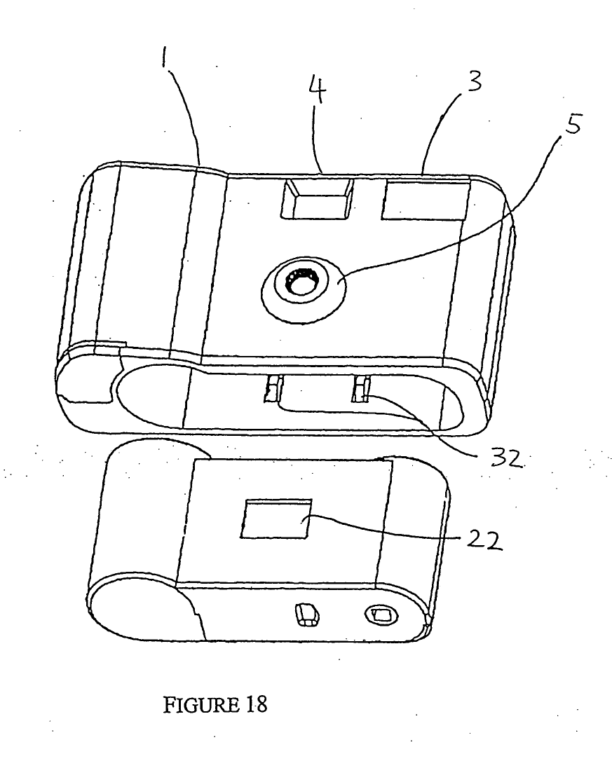

It is also envisaged that the cartridge of the present invention, for example shown in FIGS. 3-6, may come in a form where there is no door provided and where the aperture 22 for the dark room 10 is not light sealable independent from being engaged with the camera body. This embodiment is for example shown in FIG. 18. The cartridge in this form may for example be substantially provided as shown in FIGS. 3-6 save for the provision of the door 13. The cartridge in a pre-used condition for example provides the film in a preloaded condition where the film is collected by a canister 6 provided at the second spool region and a substantial portion of the film is spooled in the unexposed film spooling region 12. That portion of the film extending between the two spooling regions and through the dark room will in such situations be exposed to light entering through the aperture 22. In such a pre-used condition the first frame of the film will be exposed. However, once the cartridge is inserted into the camera body, the subsequent winding on of the film onto the canister 6 will present the subsequent frames for appropriate exposure in capturing the image projected through the lens aperture and shutter of the camera body. The images that are then captured and wound onto the canister will then be retained in the canister in a light sealed environment. In order to ensure that the unexposed film in the unexposed film spooling region also remains unexposed at times where the cartridge is external of the camera body, this unexposed film spooling region is also light sealed. Such light sealing is preferably achieved by ensuring that the film extending from the unexposed film spooling region extends through a very narrow slot (as for example similar to the slot provided in the film canister) thereby preventing light from entering into the unexposed film spooling region. Such configuration is desirable whether or not the cartridge is provided with or without the door. Should the cartridge be removed from the camera midway during use, that frame presented in the dark room will become exposed to light. However, upon reinsertion of the cartridge into the camera body or another camera body, it merely requires the winding on of the film to advance the film to present an unexposed frame in the dark room for the subsequent exposure for capturing the next image. At the end of use of the cartridge, the film will have been wound on fully into the canister which can then be removed from the casing of the cartridge for processing by standard processing equipment.

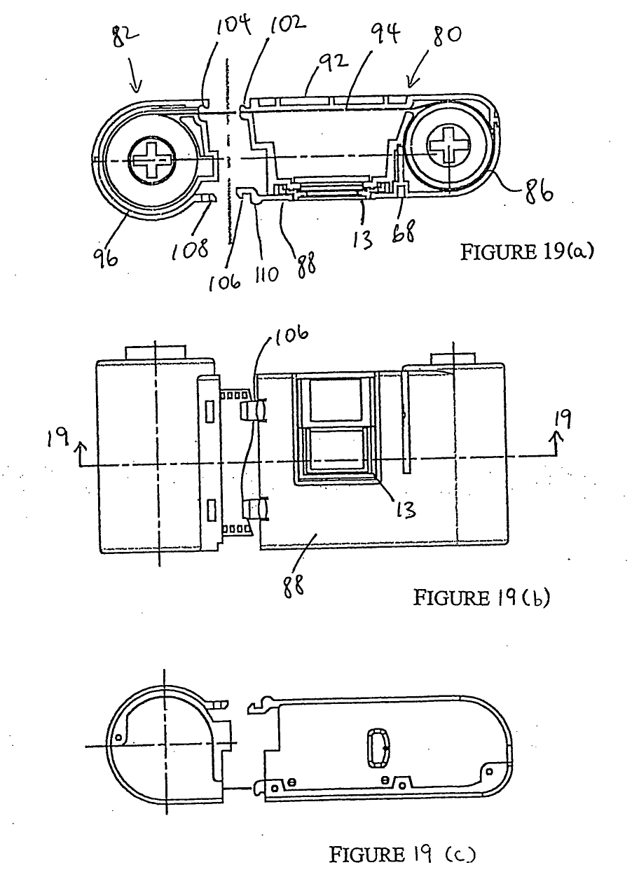

FIGS. 19a, 19b and 19c illustrate an alternative embodiment of a film cartridge 80 comprised of two main parts, the exposed film spooler region 82 where the exposed film is collected and the rest of the cartridge 84. The unexposed film is retained in a first spool region 86 of the rest of the cartridge 84. That portion 84 also includes the door 13 aperture 22 and the front 88 and rear plate 92 of the cartridge. The cartridge parts 82 and 84 are manufactured separately and after the film is loaded, they may be joined. The film 94 is drawn out of the region 86 toward the spool 96 which may be a film cannister or a wind-up reel.

After the initial portion of the film is wound on the spool 96, the cartridge parts 82 and 84 are adjoined. Illustrated are upper and lower sets of cooperating projections 102 on part 84 and cooperating locking groove 104 on part 82. To separably latch the cartridge parts, at the front of the cartridge there are two hooks 106 on part 84 which snap into receiving grooves or openings 108 on the cartridge part 82. With the projection 102 and the latch 104 and the latch 106 snapped into the groove 108, the cartridge is integrated. Upon completion of photography and whether it is desired to remove the wound film from the camera, the portions of the cartridge may again be separated for example by applying force to the release button 110 on the latch 106 for separating the latch 106 from the groove 108, and thereafter separating the projection 102 from the notch 104. A film cannister can be removed from the spooling region 96.

This cartridge also permits reloading, since new film may be loaded with a spooler in the portion 84. This arrangement has the benefit of enabling reloading of the cartridge with new film without having to thereafter form the cartridge around the installed film and more important, enables removal of film from the cartridge simply and without destroying the cartridge, which enables the cartridge to be reused.

This arrangement is also particularly useful for a loading technique where the supply of unexposed film is provided in a conventional film cannister, which can be put into the spooling region 96. Then the film to be used for the photography is led out of the spooling region 96 and wound into the spooling region 86, and before photograph begins. During photography, the film would be refed back to the cannister at region 96 so that by completion of photography, exposed film would be back in the cannister at region 96, which cannister had supplied the initial unexposed film.

The film cartridge can easily be ejected from the camera body when a switch is pushed releasing the film cartridge from the camera body. The camera body can in this way be used many times, and the film cartridge may also be recycled with new film loaded into it. Further, the removable/replaceable feature as indicated above enables the change of different types of film to suit different uses (e.g. different ASA) or the grouping of photos of a particular nature in a particular roll of film/film set (e.g. different occasions, different groups of people, different subject matters etc). Interchangeability of camera bodies for one film cartridge can also be achieved with the present invention. A camera body which provides particular features such as a wide angled lens, a colored lens or other effect type lens may be provided, where the film cartridge of the present invention is interchangeable between such bodies.

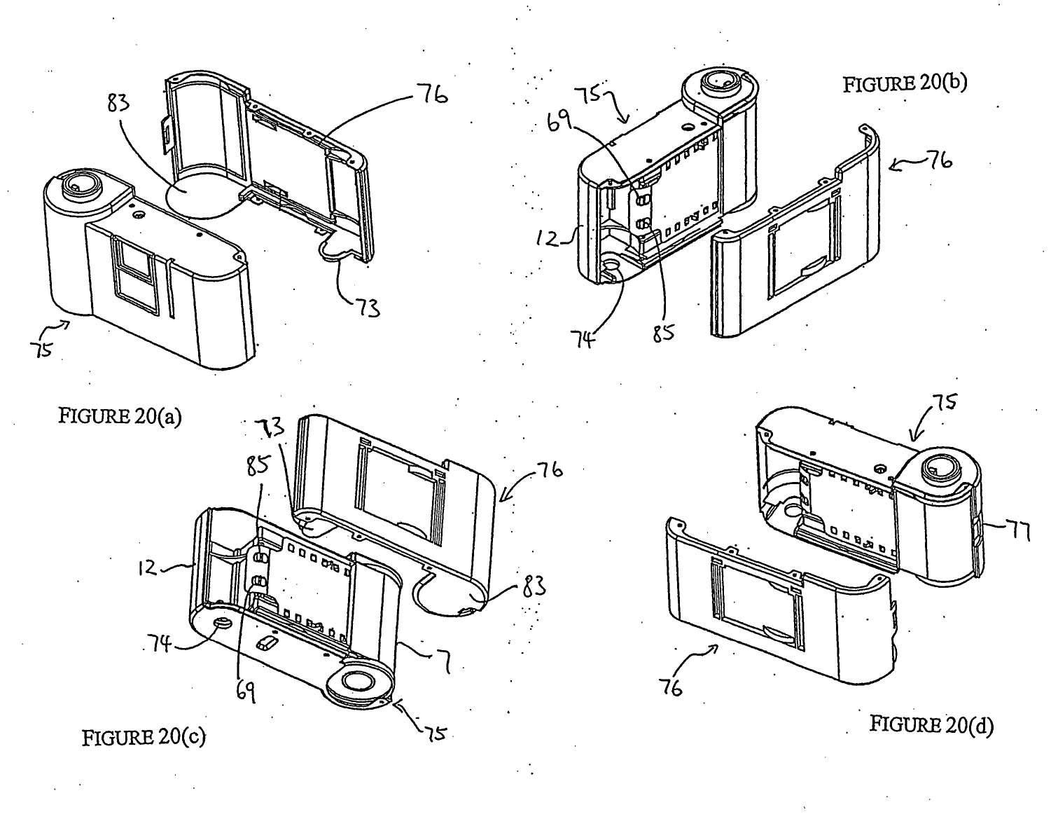

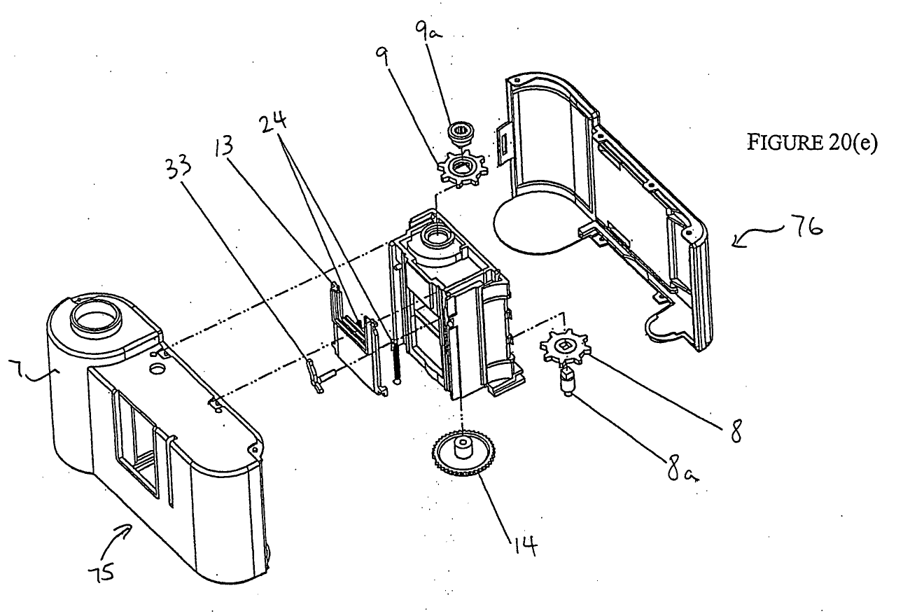

FIGS. 20a, 20b, 20c, 20d and 20e illustrates another embodiment of the cartridge 2 in which the cartridge 2 comprises a body part 75 and a cover part 76. The body part 75 substantially comprises both the unexposed spooling region 12 and the collection region 7. The body part 75 and the cover part 76 are connected together along their peripheral, e.g., by snapping the peripheral of the cover part 76 into the peripheral of the body part 75. A latch 77 is provided at the collection region 7 to secure the connection after assembling.

In the cover part 76, rims 78 are provided at the upper and bottom edges to bear against the film to locate it in position relative to the cartridge. Two slots 79 are provided to accommodate the sprockets after assembling so as to save room in the cartridge. The bottom of the cover part 76 are provided with two bulging portions corresponding to the two spool regions 7 and 12 in the body part 75 respectively. The smaller bulging portion 73 is used to cover a hole 74 in the bottom of the body part 75. Purpose of the hole 74 is for loading the film in the unexposed region 12, which will be explained in detail below. The larger bulging portion 73 covers the bottom of collection region 7 after the assembling of the cartridge.

A pair of stops 85 is provided at the inside of the unexposed region 12 of the body part 75, on which an end of the film is secured by a pair of holes, so to avoid further advancement of film when the whole roll of film has been completely exposed. With the stops 85, the motor of the camera will stop once the film is exhausted and the user can not press the shutter button any further.

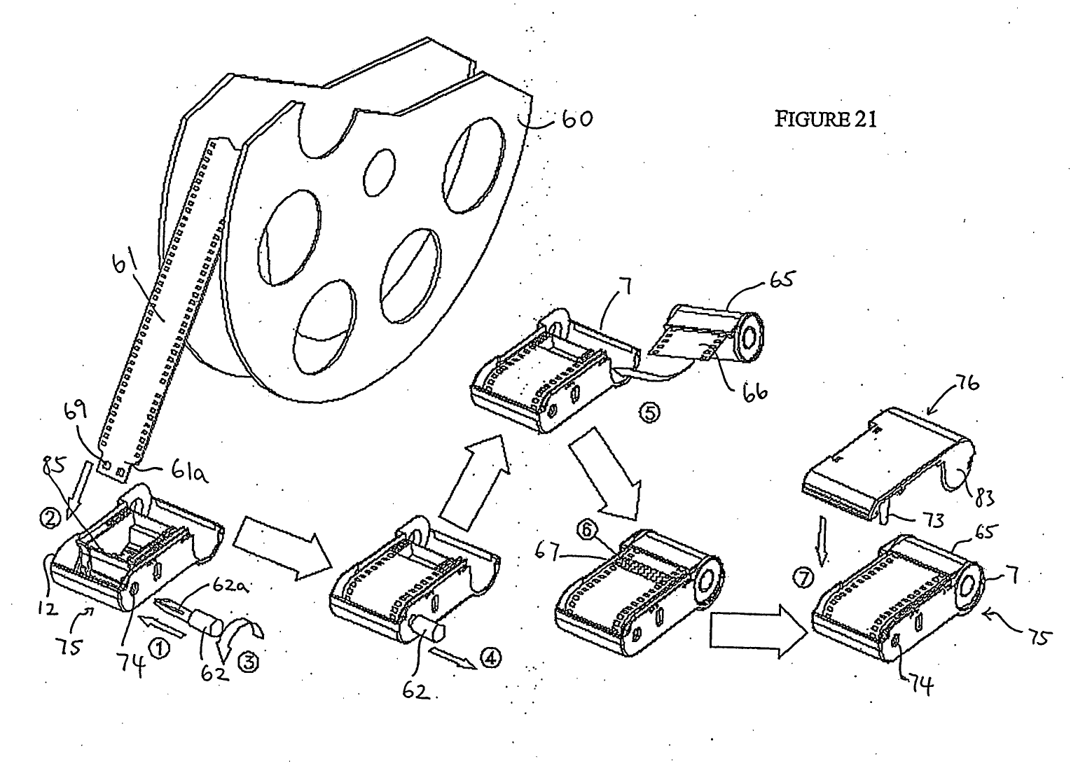

An exploded perspective view of the cartridge 2 is shown in FIG. 20e, which is similar to FIG. 6(a). However, it shall be noted that there is no spool in the unexposed region 12 in this embodiment. The process for loading the film in to the cartridge shown in FIG. 20 is illustrated in FIG. 21.

As shown in FIG. 21, the film is loaded to the body part 75 of the cartridge 2 from a film spindle 60. The free end 61a of the film 61 is pulled out from the spindle 60 with the holes 69 at the free end 61a hooked to the stops 85 provided inside the unexposed spooling region 12. Then a spooling driver 62 is inserted into the unexposed region 12 from the hole 74 at the bottom of the body part 75. The driver 62 is provided with longitudinal slots 62a with an open end. The film 61 is inserted in the slots 62a and kept therein. Rotation of the driver 62 spools the film 61 and forms a film roll inside the unexposed region 12. After a predetermined length of film 61 is spooled, the film 61 is cut from the spindle 60 and the driver 62 is removed from the body part 75 of the cartridge. A collection container or canister 65 with a film stud 66 is placed into the collection region 7, and the cut end of the film 61 spooled in the unexposed region 12 is connected to the film stud 66, e.g., by an adhesive tape 67. Finally, the cover part 76 joins the body part 75 to form the cartridge 2, with the smaller bulging portion 73 covering the hole 74. The larger bulging region 83 covers the bottom the collection region 7. A light seal cartridge 2 with the film preloaded therein is thus ready for use.

When using the camera to take photos, the used film is collected in the collection container or canister 65 frame by frame upon exposure. After the film roll is completely used, the user may send the canister 65, which is preferably of a 135 standard, to any photo development store which will handle the canister just like a regular 135 film canister. No special machines or device is needed for the store to handle the film. No special experience or skill is required for the personnel in the store. Of course, the user may also send the cartridge with the canister 65 inside to the store, and let the store people to take the canister out. In any case, the canister 65 will be handled by a standard machine for developing regular film canisters, which is available in virtually all the photo development stores.

As an alternative, the film may be loaded from a standard film canister, e.g., an 135 film canister instead from the spindle 60. In such a case, the user may load the film by himself from a commercially available regular film canister. Preferably, the film is loaded after the cover part 75 is assembled with the body part 74, with proper film loading device (e.g., the spooling driver 62) to draw the film out from the canister 65 placed in the collection region 7 and spool the film in the unexposed region 12. Then, the canister 65 serves as a collection canister to collect the film frame by frame upon each exposure. Although the users may need to have some knowledge in loading the film, they can still benefit from the exchangeability of different cartridges.

A further alternative is that two canisters are preloaded in the cartridge 2. An unexposed film canister is placed in the unexposed spooling region 12 while a collection canister is placed in the collection region 7. When loading the film before use, a free end of the film is pulled out from the unexposed film canister and is connected, e.g., by an adhesive tape, to a stud extended from the collection canister.

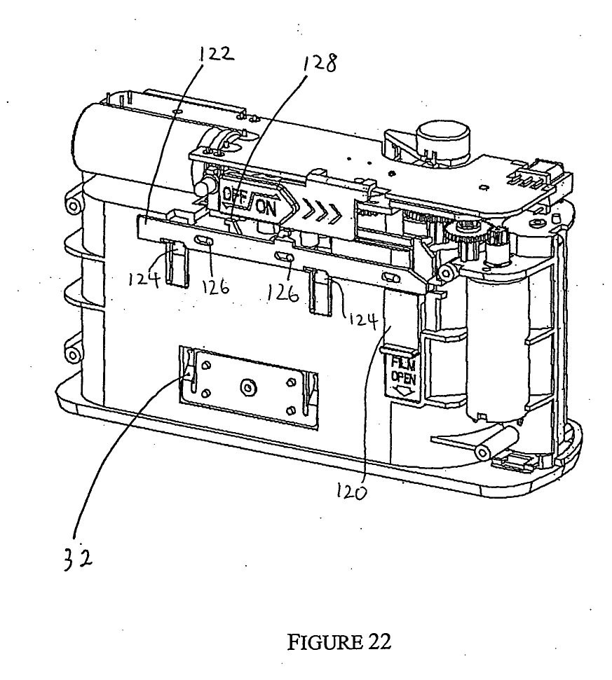

FIG. 22 shows a rear perspective view of the camera body including the means that engages an installed film cartridge. There is a film open switch 120 which when operated permits removal of the film cartridge. That film open switch 120 is in turn connected with a release lever 122 which translates left and right and in the illustrated condition to the left frees the detent tabs 124 to press against the backing plate of the film cartridge and can be retained there. The film cartridge back side has recesses therein adapted to receive those tabs 124 which locks the film cartridge in position.

Movement of the switch 120 downward moves the lever 122 to the right on its support tabs 126 fixed on the back of the cartridge until the lever 122 raises the tabs 124 which releases the bias of the tabs 124 against the cartridge, freeing the cartridge to be released. A spring 128 attached to the lever and to the camera body urges the lever to the left and returns it to the left when the switch lever 120 is raised. The detent tabs 124 are then again in position to be received in the recesses 125 in the back of the film cartridge.

A pair of spring loaded arm or spring leaves 32 are provided inside the camera body 1, which engages with the grooves 34 (FIG. 6) provided on the back of the cartridge 2 for positioning purposes. Also the spring leaves 32 may prevent the cartridge 2 from accidentally dropping from the camera body 1 when the cartridge 2 is not fully accepted inside the camera body 2, in which case the detent tabs 124 may not have engaged with the recesses 125.

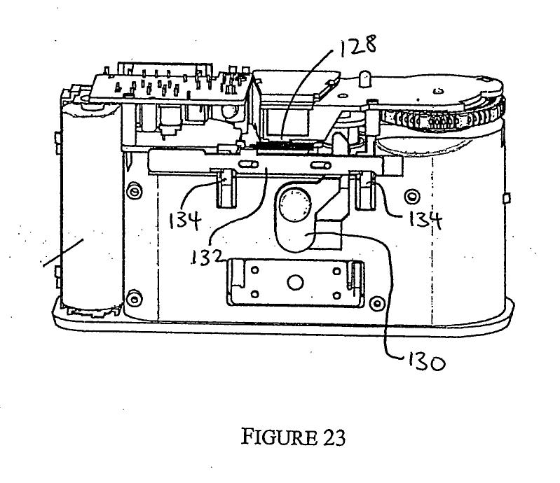

FIG. 23 is a rear view of an alternate view of the back of a camera with some elements exposed. It shows a different shape for the switch lever 132 to release the tabs 134 as in the previous embodiment.

Notably, in all preferred embodiments, the light tight 35 mm standard film cartridge is itself placed within an additional cartridge (e.g. 2). The additional cartridge 2 may itself be light tight in a selected condition (e.g. when the film door is closed), or may be light tight other than an exposure opening large enough for one frame. Thus, the outer cartridge may either be selectively light tight or light tight but for an opening sufficient for a single exposure frame.

The film may be loaded into the cartridge by pulling the film out of a container in a darkroom, and placing the roll of unexposed film and the now empty container into the cartridge 2, and then closing the cartridge. Alternatively, the cartridge may be loaded by pulling a rolled length of film from a bulk film dispensing device, commonly known in the art as a film “pancake”, and then attaching the end of the film to a container. The container and the rolled film can then be placed into the cartridge. Finally, it is also possible to spin the film out of the container after the container is placed within the cartridge 2 by spinning a spool to which the free end of the film is connected, and then optionally removing the spool. The cartridge may be closed or open while such spinning occurs.

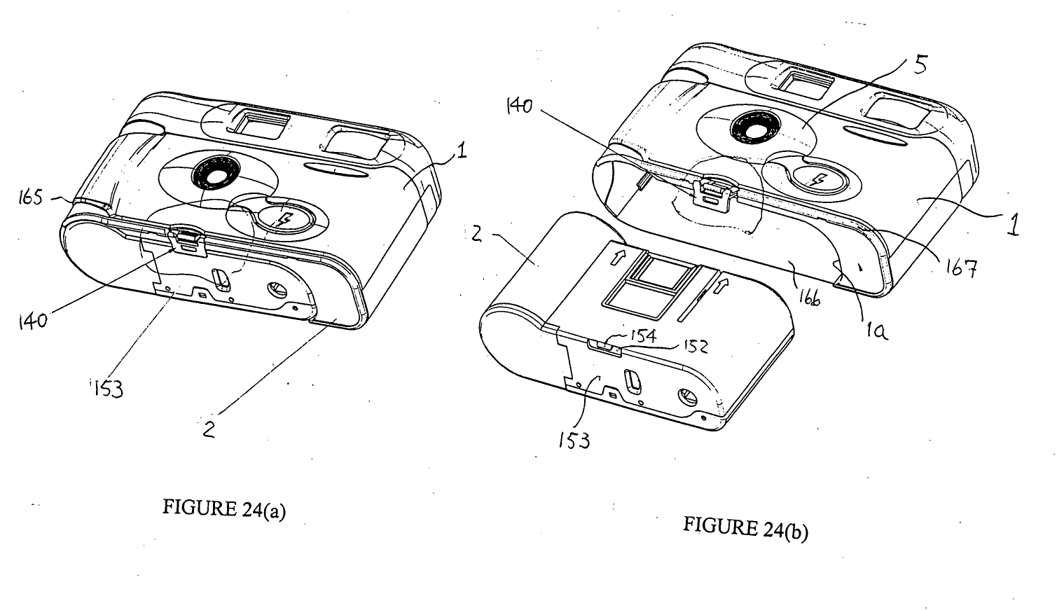

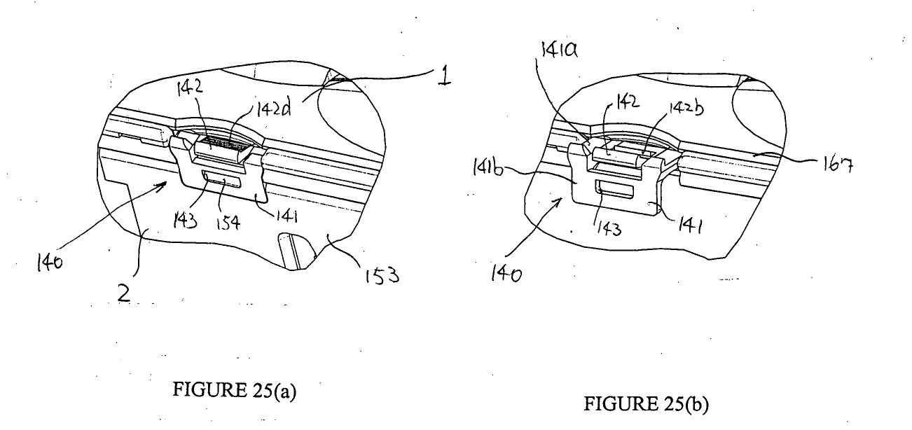

FIGS. 24(a) and 24(b) show an alternative self-locking mechanism 140 for keeping the film cartridge 2 in the receptacle 1a of the camera body 2, which is shown in an enlarged scale in FIGS. 25(a) and 25(b). In FIG. 25(a), the self-locking mechanism 140 is in its locking position preventing the film cartridge 2 from leaving the camera body 1, while in FIG. 25(b), the self-locking mechanism 140 is in its release position.

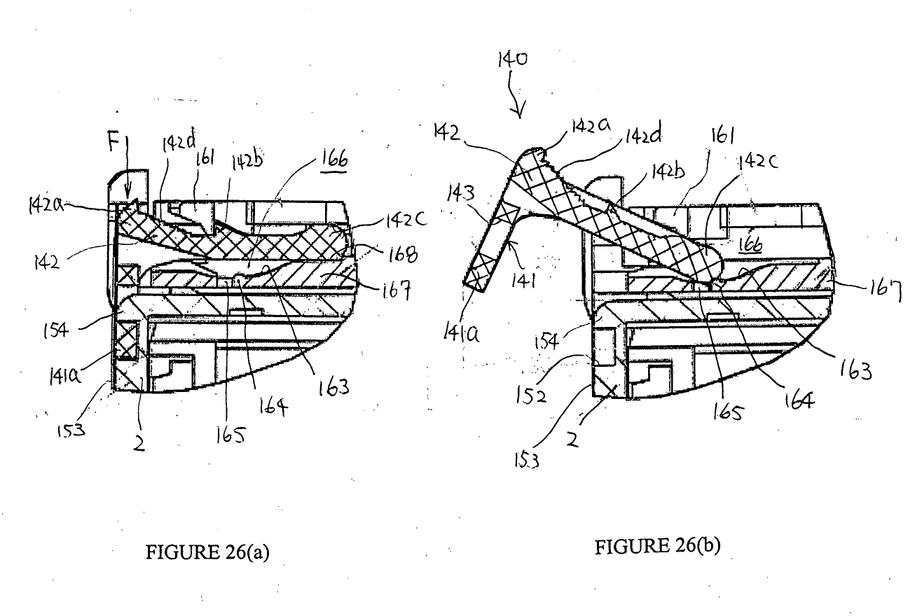

As shown in FIGS. 25(a) and 25(b), the self-locking mechanism 140 is an integral element which comprises an L-shaped holder 141 and a lock 142. The L-shaped holder 141 has a leg portion 141a and an arm portion 141b. As further shown in FIGS. 26(a) and 26(b), the lock 142 is an elongated resilient element located between two parallel legs of the leg portion 141a and is connected with the leg portion 141a at a bulb-like end 142c. The leg portion 141a is kept inside a narrow slot space 166 formed in the front wall 167 of the camera body 1. Preferably, the wall 167 also bears some other elements such as the lens 5. The lock 142 is also kept in the slot space 166, with a release end 142a protruding out of the slot space 166 from the camera body 1.

In the locking position as shown in FIG. 25(a), the leg portion 141a retreats in the slot space 166 of the camera body 1, and the arm portion 141b rests on the bottom surface 153 of the film cartridge 2 to hold the cartridge 2 inside the camera body 1. In the release position as shown in FIG. 25(b), the leg portion 141a protrudes from the camera body 1, and the arm portion 141b leaves and turns away from the cartridge 2 (also see FIG. 26(b)) so that the cartridge 2 can move out of the receptacle 1a of the camera body 1 with no obstruction from the holder 141.

As shown in FIGS. 26(a) and 26(b), in the locking position, the resilient lock 142 retreats into the slot space 166, leaving only the release end 142a outside the slot space 166. A barb 142b provided at about a halfway of the elongate lock 142 engages with a stop 161 formed on the wall 167 of the camera body 1, preventing the lock 142 and therefore the holder 141 from leaving the slot space 166. With the engagement of the barb 142b of the lock 142 with the stop 161 of the camera body 1, the whole self-locking 140 is kept in its locking position as shown in FIG. 25(a).

To release the self-locking mechanism 140 from the locking position, a user can push the release end 142a of the lock 142 toward the film cartridge 2 in a direction as shown by an arrow F. Because of its resilience, the lock 142 bends inwards and pivots around the bulb end 142c which is held in a slot 168 formed in the wall 167, whereby the barb 142b is disengaged from the stop 161. Then, while keeping pushing the lock 142 towards its bent position, the user can pull the lock 142 a little bit out of the slot space 166 with the help of the hook-shaped release end 142a, whereby the bulb end 142 leaves the slot 168 and falls on a curved surface 163 formed on the wall 167. Following the movement of the lock 142, the holder 141 is now also lifted a little bit from its locking, the arm portion 141b leaves the bottom surface 153 of the film cartridge 2. Further pulling on the release end 142a of the lock 142 or the arm portion 141b of the holder 141 turns the lock 142 as well as the holder 141 in a direction away from the film cartridge 2, as the bulb end 142c moves along the curved surface 163 until it falls in a groove 165 and rests on a small bulge 164, as shown in FIG. 26(b). The bulge 164 helps the self-locking mechanism 140 to stay in this full release position. Thus, in the full release position as shown in FIG. 26(b), the arm portion 141a gets out of the path along which the film cartridge 2 will be removed from the camera body 1.

To return to the locking position as shown in FIG. 26(a) so as to keep the film cartridge 2 inside the camera body 1, reverse procedures are followed. After the cartridge 2 is inserted in the receptacle 1a of the camera body 1, the lock 142 and the holder 141 are pushed toward the cartridge 2, which will disengage the bulb end 142c from the small bulge 164 and move the bulb end 142c from the groove 165 onto the curved surface 163. Further pushing the lock 142 and the holder 141 drives the bulb end 142c moving along the curved surface 163 toward the slot 168, and, at the same time, the arm portion 141a of the holder 141 turns back toward the film cartridge 2 and rests on the bottom surface 153 of the cartridge 2. The barb 142b returns to its engagement with the stop 161, preventing the lock 142 and the holder 141 from leaving the camera body 1, as shown in FIG. 26(a).

As shown in FIGS. 26(a) and 26(b), as well as in FIG. 25(a), the lock 142 is preferably provided with a toothed surface 142d near the release end 142a, which helps a user to garb the lock 142 by a finger.

Preferably, the bottom surface 153 of the film cartridge 2 is formed with a recess 152 for accommodating the arm portion 141a when the holder 141 is in the locking position as best shown in FIGS. 25(a) and 26(a). Thus, the arm portion 141a can be flush with the bottom surface 153 when the cartridge 2 is fully held in the camera body 1.

Preferably, a hole-hook engagement may also be provided to help the arm portion 141a to rest in the recess 152. In particular, a ridge 154 is formed in the recess 152, which engages with a hole 143 formed in the arm portion 141a when the cartridge 2 is held by the arm portion 141a in the locking position.

Preferably, a cut-away portion 165 is provided on a side surface of the camera body 1, as shown in FIGS. 24(a) and 24(b), which facilitates the removal of the cartridge 2 from the receptacle 1a of the camera body 1 after the self-locking mechanism 140 is released. As an alternative, a biasing spring can be provided inside the receptacle 1a, either on the camera body 1 or the cartridge 2, to force the film cartridge 2 to move slightly out of the receptacle 1a when the self-locking mechanism 140 is in its release position, thus facilitating removal of the cartridge by hand. For example, this can be realized by the spring 24 shown in FIGS. 8(a)-8(c), which interacts with the safety lock 33 that abuts against the protrusion web 70 of the camera body 1.

As shown in FIGS. 24(a) and 24(b), to save the manufacturing cost, the back of the camera body 1 can be generally open, while the cartridge 2 is held in the receptacle 1a only by concave side walls as well as the front wall 167. The open back may be covered by a paper sheet 166, on which the instructions of using the camera are conveniently printed.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A camera comprising:
a photographic film cartridge forming a dark room for accommodating a film, and a camera body having a receptacle for removably and snugly accepting said cartridge therein,
wherein said cartridge is provided with an opening which remains closed when said cartridge is removed from said receptacle, and is openable for exposing said film to a light control device to form an image on said film when said cartridge is accepted in said receptacle.

2. The camera of claim 1 wherein said cartridge is provided with a door selectively movable between a closed position to close said opening and an open position to open said opening.

3. The camera of claim 2 wherein said cartridge further comprises a spring forcing said door toward said closed position.

4. The camera of claim 3 further comprising an activator for moving said door from said closed position to said open position against said spring.

5. The camera of claim 4 wherein said activator is adapted to move said door to its open position upon insertion of said cartridge into said camera body.

6. The camera of claim 4 wherein said activator is adapted to move said door to its open position upon a manual operation after said cartridge is accepted in said camera body.

7. The camera of claim 5 wherein said manual operation is an actuation on a shutter of said camera for taking a frame of photo.

8. The camera of claim 7 wherein said shutter is formed by said door.

9. The camera of claim 7 wherein said shutter is provided on said camera body and a button is provided for said actuation of said shutter.

10. The camera of claim 9 wherein an interlock mechanism is provided between said activator for moving said door and said button for actuating said shutter.

11. The camera of claim 2 wherein said door is adapted to pivotably move between said closed position and said open position.

12. The camera of claim 2 wherein said door is adapted to move linearly between said closed position and said open position.

13. The camera of claim 4 wherein said activator is a protrusion provided on an internal wall of said receptacle of said camera body for pushing said door to its open position against said spring when said cartridge is being inserted into said receptacle.

14. The camera of claim 2 wherein said cartridge is further provided with a safety latch movably between a first position in which said door is prevented from moving and a second position in which said door is allowed to move by said activator.

15. The camera of claim 14 wherein said safety latch remains in said first position when said cartridge is not accepted in said receptacle of said camera body.

16. The camera of claim 15 wherein a spring is provided to force said safety latch to remain in said first position.

17. The camera of claim 16 wherein an unlocking element is provided to move said safety latch from said first position to said second position.

18. The camera of claim 17 wherein said unlocking element is adapted to operate upon insertion of said cartridge into said receptacle of said camera body.

19. The camera of claim 18 wherein said unlocking element is a protrusion provided on an inner wall of said receptacle of said camera body.

20. The camera of claim 19 wherein said unlocking element is adapted to keep said safety latch at said second position when said cartridge remains inside said receptacle.

21. The camera of claim 14 wherein said safety latch comprises a latch arm which rests in a notch on said door when said safety latch is in said first position.

22. The camera of claim 1 wherein said cartridge comprises a first spool region, a second spool region and a bridging region between said two spool regions, and said opening is provided on said bridging region.

23. The camera of claim 22 wherein said film is initially accommodated in said first spool region and is exposed through said opening when being advanced through said bridging region to said second spool region.

24. The camera of claim 23 wherein said second spool region is provided with a film canister for accepting said film advanced from said first region.

25. The camera of claim 24 wherein said cartridge has a bulging contour in shape at said second spool region, which is obviously larger than that at said first spool region.

26. The camera of claim 23 wherein said first spool region is provided with a film canister for containing said film before being advanced to said second region.

27. The camera of claim 26 wherein said cartridge further comprises means for rewinding said film back to said canister in said first spool region after said film is all exposed.

28. The camera of claim 24 wherein said cartridge includes a first part having said first spool region and a second part having said second spool region, and wherein said two parts are detachably attached together to form said cartridge.

29. The camera of claim 1 wherein said light control device is a lens.

30. The camera of claim 29 wherein said lens is provided on said camera body.

31. The camera of claim 29 wherein said lens is provided on said cartridge and covers on said opening, and a shutter is provided on said camera body.

32. The camera of claim 1 further comprising a locking mechanism for keeping said cartridge inside said receptacle of said camera body after said cartridge is accepted in said receptacle.

33. The camera of claim 32 wherein said locking mechanism comprises a resilient tab provided on said camera body which engages with a recess formed on said cartridge when said cartridge is fully accepted in said receptacle.

34. The camera of claim 33 further comprises a releasing element on said camera body for releasing said resilient tab from said recess on said cartridge and for removing said cartridge from said receptacle.

35. A film cartridge detachably attachable to a camera body having a light control device, comprising:
a light sealed housing forming a dark room for accommodating a film, wherein said housing is provided with an opening which remains closed with a door when said cartridge is detached from said camera body and is openable for exposing said film to said light control device when said cartridge is attached to said camera body.

36. The film cartridge of claim 35 further comprising a locking element remaining on a locking position for keeping said door closed when said cartridge is detached from said camera body.

37. The film cartridge of claim 36 further comprising an unlocking mechanism to for removing said locking element from said locking position upon attachment of said cartridge to said camera body.

38. The film cartridge of claim 37 further comprises an activation mechanism to open said door.

39. The film cartridge of claim 38 wherein said activation mechanism is designed such that said door is opened upon attachment of said cartridge to said camera body.

40. The film cartridge of claim 38 wherein said activation mechanism is designed such that said door is opened upon activation of a shutter for taking a photo.

41. The film cartridge of claim 40 wherein said shutter is formed by said door.

42. The film cartridge of claim 40 further comprising an interlock element to implement said activation of said door by a button for activating said shutter.

43. A camera body, comprising:
a light control device for communicating an image on a film,
a receptacle for removably and snugly accepting a film cartridge therein, said film cartridge having a housing forming a dark room for accommodating said film therein but with an opening which remains closed by a door when said cartridge is outside said receptacle;
said camera body comprises an activation mechanism for opening said door to expose a frame of said film to said light control device through said opening when said cartridge is accepted in said receptacle.

44. The camera body of claim 43 wherein said activation mechanism is designed such that said door is opened upon insertion of said cartridge into said receptacle.

45. The camera body of claim 44 wherein said activation mechanism is designed such that said door is opened each time a shutter activated.

46. The camera body of claim 45 wherein said shutter is formed by said door.

47. The camera body of claim 45 further comprises a button for activating said shutter.

48. The camera body of claim 47 further comprising an mechanism for interlocking between said door and button such that said door is opened upon pushing said button to activate said shutter.

49. A camera comprising:
a camera body having a light control device for communicating an image to a film, and
a photographic film cartridge detachably attachable to said camera body, wherein said cartridge comprises a light sealed housing forming a dark room for accommodating said film but with an opening sized for exposing only one single frame of said film and positioned for exposing said single frame to said light control device when said cartridge is attached to said camera body.

50. A film cartridge, comprising a light sealed housing forming a dark room for accommodating a film therein but with an opening sized for exposing only a single frame of said film, said film being contained within a light tight container.

51. A camera comprising:
a photographic film cartridge forming a dark room for accommodating a film, and a camera body having a receptacle for removably and snugly accepting said cartridge therein,
wherein said cartridge is provided with an opening and a door selectively movable between a first position to close said opening and a second position to open said opening, and wherein said film is, upon exposure, within a light tight container that is within said cartridge.

52. The camera of claim 51 further comprises a biasing spring on said cartridge to force said door toward said first position.

53. The camera of claim 52 further comprises an activation mechanism for moving said door from said first position to said second position upon insertion of said cartridge into said camera body.

54. The camera of claim 53 further comprises a locking mechanism for preventing said door from being moved to said second position when said cartridge is outside said camera body.

55. The camera of claim 52 wherein said activation mechanism comprises an protrusion provided on an inner wall of said receptacle which moves said door against said biasing spring to said second position.

56. The camera of claim 54 wherein said locking mechanism comprises a safety latch pivotably movable between a locking position and an unlocking position.

57. The camera of claim 56 wherein said locking mechanism further comprises a biasing spring forcing said safety latch toward said locking position.

58. The camera of claim 57 wherein said safety latch comprises a latch arm which engages with a notch provided on said door when said safety latch is at said locking position.

59. The camera of claim 58 said cartridge is provided with a guide groove extending along a direction in which said cartridge is inserted into said receptacle, and said receptacle of said camera body is provided with a corresponding elongate web for longitudinally inserting said guide groove when said cartridge is being inserted into said receptacle.

60. The camera of claim 59 wherein said safety latch comprising an latch release lever protruding into said guide groove when said safety latch is at said locking position.

61. The camera of claim 60 wherein said elongate web is adapted to push said latch release lever away from said guide groove upon entering said groove, whereby moving said safety latch to said unlocking position and keeping it at said unlocking position by occupying said groove until said cartridge is removed from said receptacle.

62. A film cartridge for use with a camera comprising a light tight film container within an outer cartridge, said outer cartridge being either selectively light tight or being light tight but for an opening sufficient only to expose a single frame, and film within said film cartridge.

63. The film cartridge of claim 62 wherein further comprising a door that is arranged to close and lock when said film cartridge is removed from said camera.

64. The film cartridge of claim 63 wherein said door is biased to a closed position.

65. The film cartridge of claim 62 wherein a majority of said film is in said cartridge but not within said container.

66. The film cartridge of claim 65 wherein a majority of said film is in said container within said cartridge.

67. A method of loading film comprising placing unexposed film and a light tight container into a cartridge, and placing the cartridge into a camera.

68. The method of claim 67 wherein said cartridge is light tight.

69. The method of claim 67 wherein said cartridge is light tight but for an opening sufficient for a single frame exposure.

70. The method of claim 67 wherein a majority of said film is within said light tight container.

71. The method of claim 67 wherein a majority of said film is outside of said light tight container but within said cartridge.

72. A camera comprising:
a photographic film cartridge forming a dark room for accommodating a film, and a camera body having a receptacle for removably and snugly accepting said cartridge therein,
wherein said cartridge further comprises a container inside said dark room for collecting exposed films, said container being removable from said cartridge.

73. The camera of claim 72 wherein said cartridge comprises an unexposed spooling region for accommodating unused portion of the film and a collection spooling region for accommodating exposed portion of the film.

74. The camera of claim 73 wherein said container rests in said collection spooling region.

75. The camera of claim 74 wherein said container is a film canister.

76. The camera of claim 75 wherein said camera body has an opening at its bottom that is wider at one side than at the other such that the wider side accommodates a portion of the cartridge containing said container.

77. The camera of claim 73 wherein a stop is provided in said unexposed spooling region for securing a free end of said film thereon.

78. The camera of claim 73 wherein a hole is provided at a bottom of said cartridge at the position of said unexposed spooling region for accepting a spooling driver inserted therethrough for loading said film.

79. The camera of claim 73 wherein said cartridge further comprises an opening with a door selectively movable between an open position and a closed position.

80. The camera of claim 79 wherein said door remains at its closed position when said cartridge is outside the camera body.

81. The camera of claim 80 wherein said door is automatically moved to its open position upon insertion of said cartridge into said camera body.

82. The camera of claim 73 wherein said film is loaded from a film spindle into said unexposed spooling region.

83. The camera of claim 73 wherein said film is preloaded from said canister to said unexposed spooling region before use.

84. A cartridge detachably attachable to a camera body for accommodating a film therein, comprising a body part comprising an unexposed spooling region and a collection region, and a cover part for engaging with said body part to form a light sealed dark room, wherein said body part has a hole at a bottom of said unexposed spooling region for receiving a spooling driver to spool film in said unexposed region.

85. The cartridge of claim 84 wherein said spooling driver is provided with longitudinal slots for film to be held therein.

86. The cartridge of claim 85 wherein said slots is open at a free end of said driver.

87. The cartridge of claim 84 wherein said body part is provided with a stop inside said unexposed spooling region for securing a free end of said film thereon.

88. The cartridge of claim 84 further comprises a collection container placed in said collection region for collecting exposed film therein.

89. The cartridge of claim 88 wherein said collection container is a 135 m standard canister.

90. A spooling driver for loading film in a cartridge as in claim 1, wherein said driver has at least one longitudinal slot for accepting said film therein so as to form a film roll by rotating said driver.

91. The spool driver of claim 90 wherein said slot is open at an free end of said driver.

92. A camera comprising:
a photographic film cartridge forming a dark room for accommodating a film, said cartridge comprising a collection spool for collecting exposed frames of said film, and
a camera body having a receptacle for removably and snugly accepting said cartridge therein, said camera body comprising a control means to drive said collection spool to collect said exposed frames upon activation of a shutter of said camera,
wherein said control means comprises a driving shaft with a protrusion on its peripheral surface which is adapted to laterally abut a block inside a receptacle formed on said collection spool for accepting said driving shaft, and said driving shaft is biased toward said receptacle by a spring.

93. The camera of claim 92 wherein said control means further comprises a sleeve into which said driving shaft retreats when it is pushed against said biasing spring.

94. The camera of claim 93 wherein said control means further comprises a toothed wheel which is interlocked with an activation mechanism that triggers said shutter of the camera.

95. The camera of claim 94 wherein said sleeve is fixed to said toothed wheel.

96. A camera comprising:
a photographic film cartridge forming a dark room for accommodating a film, said cartridge comprising a sprocket for advancing said film upon exposure, and
a camera body having a receptacle for removably and snugly accepting said cartridge therein, said camera body comprising a control means for driving said sprocket upon actuation of a shutter of said camera,
wherein said sprocket comprises a sleeve with inner teeth, while said control means comprises a toothed shaft for engaging with said inner teeth of said sleeve.

97. The camera of claim 96 wherein said toothed shaft of said control means has a tapered end for facilitating insertion of said toothed shaft into said toothed sleeve of said sprocket.

98. The camera of claim 96 wherein said control means is interlocked with an activation mechanism that triggers said shutter of the camera.

99. A film cartridge comprising a light sealed housing forming a dark room for accommodating a film therein, wherein said cartridge comprises a container inside said dark room for collecting exposed films, said container being removable from said cartridge.

100. The cartridge of claim 99, wherein said container is removable from said cartridge without destroying said cartridge.

101. The cartridge of claim 99 comprising two parts which are detachably connected to form said cartridge whereby said container is removable from said cartridge by detaching said two parts from each other.

102. The cartridge of claim 99 further comprising an opening closable by a door to form said dark room and openable to expose a frame of said film while taking a photograph.

103. In combination, a camera body and a photographic film cartridge detachably attachable to the camera body, the combination comprising: the camera body including a light control device for communicating an image to a film in the cartridge in the camera body, and camera operating elements for permitting communication of an image through the light control device to the film; the cartridge comprising an unexposed film spool region, a second spool region spaced from the unexposed film spool region and a bridging portion between the unexposed film spool region and the second spool region such that the film can be advanced from the unexposed film spool region past the bridging portion to the second spool region, and when the cartridge is in the camera body, the bridging portion is positioned with respect to a lens in the camera body so that an image can be captured on film then at the bridging portion; film operating elements in the camera body and cooperating film operating elements on the cartridge for being operated together for advancing the film in the cartridge from the unexposed film spool region to the second spool region past the bridging portion; the bridging portion being so shaped with respect to the cartridge and the camera body as to define a dark room for film passing between the unexposed film spool region and the second spool region; a light transmission opening in the cartridge at the bridging portion, the opening being positioned such that when the cartridge is in engagement with the camera body, and with the opening open, film at the bridging portion is presented for exposure by light passing the lens and the opening in the film cartridge; a door on the film cartridge, the door is shaped to prevent light from entering through the opening into the darkroom in the cartridge; the door being selectively moveable between a closed position where the door blocks the opening in the cartridge and an open position wherein the door has been moved to open the opening in the cartridge and permit exposure of film at the bridging region in the darkroom.

104. The combination of claim 103, wherein the door is adapted to remain in the closed position until the cartridge is fully engaged in the camera body.

105. The combination of claim 104, further comprising cooperating devices on the camera body and at the door on the cartridge for moving the door to the open position upon the cartridge being fully engaged with the camera body.

106. The combination of claim 105, wherein when the cartridge and the camera body are fully engaged, the cartridge being shaped to define a region which is light sealed except for light entering the camera body and into the cartridge by the lens for exposing film in the bridging portion of the cartridge.

107. The combination of claim 105, further comprising an actuator connected with the door for moving the door between the open and closed positions.

108. The combination of claim 107, further comprising a safety latch on the cartridge for the door, and the actuator cooperating with the safety latch for releasing the safety latch for enabling movement of the door from the closed position to the open position.

109. The combination of claim 108, further comprising a spring connected with the door for moving the door from the closed position to the open position upon release of the latch.

110. The combination of claim 107, further comprising the door being pivotally supported to the cartridge to pivot between the open and closed positions.

111. The combination of claim 107, wherein the door is supported to the cartridge to translate along the cartridge between the closed and open positions.

112. The combination of claim 108, further comprising the safety latch for the door being operable to free the door to move from the open to the closed position thereof.

113. The combination of claim 112, further comprising a spring for moving the door from the open to the closed position thereof.

114. The combination of claim 112, wherein the actuator is so connected to the cartridge and the camera body as to be operable to move the door between the positions thereof upon engagement and upon removal of the cartridge and the camera body.

115. The combination of claim 107, wherein the actuator is user operable and is operable upon full engagement of the cartridge with the camera body.

116. The combination of claim 107, wherein the camera body includes a shutter at the lens and includes an operator for operating the shutter.

117. The combination of claim 116, wherein the shutter operator is connected with the actuator such that the actuator is operated for moving the door from the closed to the open position upon operation of the shutter.

118. The combination of claim 103, further comprising a film or canister for the film and located at the unexposed film spool region of the cartridge, such that during advancement of the film past the bridging portion, the film is transferred from the canister to the second spool region.

119. The combination of claim 103, further comprising a canister for the film and located at the second spool region of the cartridge, such that during advancement of the film for exposure past the bridging portion, the film is transferred from the second spool region to the canister.

120. The combination of claim 103, further comprising a shutter on the camera body for selectively blocking and opening the light control device and an operator on the camera body connected with the shutter and operable for opening the light control device.

121. The combination of claim 103, wherein the film cartridge comprises a housing in which the film is disposed and the housing being shaped to seal the film from exposure to light except through the opening closeable by the door.

122. The combination of claim 121, further comprising a narrow slot between the unexposed spool region and the bridging portion through which the film can pass and the slot being narrowed to substantially seal the unexposed film spool region from light.

123. The combination of claim 103, wherein the camera body has an enclosed chamber therein and the cartridge is shaped to be received in and is receivable in the chamber in the camera body to define the combination, and wherein the door is operable to the open position only with the cartridge fully installed in the camera body.

124. A photographic film cartridge for detachable attachment to a camera body, the film cartridge comprising: an unexposed film spool region, a second spool region spaced from the unexposed film spool region and a bridging portion between the unexposed film spool region and the second spool region such that the film can be advanced from the unexposed film spool region past the bridging portion to the second spool region; the bridging portion being so shaped with respect to the cartridge and the camera body as to define a dark room for film passing between the unexposed film spool region and the second spool region; a light transmission opening in the cartridge at the bridging portion, the opening being positioned such that when the cartridge is in engagement with the camera body, and with the opening open, film at the bridging portion is presented for exposure by light passing the lens and the opening in the film cartridge; a door on the film cartridge, the door is shaped to prevent light from entering through the opening into the darkroom in the cartridge; the door being selectively moveable between a closed position where the door blocks the opening in the cartridge and an open position wherein the door has been moved to open the opening in the cartridge and permit exposure of film at the bridging region in the darkroom.

125. The cartridge of claim 124, further comprising an actuator connected with the door for moving the door between the open and closed positions.

126. The cartridge of claim 125, further comprising a safety latch on the cartridge for the door, and the actuator cooperating with the safety latch for releasing the safety latch for enabling movement of the door from the closed position to the open position.

127. The cartridge of claim 126, further comprising a spring connected with the door for moving the door from the open to the closed positions upon release of the latch.

128. The cartridge of claim 124, further comprising a film or a canister for the film located at the unexposed film spool region of the cartridge, and during advancement of the film past the bridging portion, the film is transferred to the second spool region.

129. The cartridge of claim 124, further comprising a canister for the film located at the second spool region of the cartridge, such that during advancement of the film for exposure past the bridging portion, the film is transferred to the canister.

130. The cartridge of claim 124, wherein the film cartridge comprises a housing in which the film is disposed and the housing being shaped to seal the film from exposure to light except through the opening closeable by the door.

131. The cartridge of claim 130, further comprising a narrow slot between the unexposed spool region and the bridging portion through which the film can pass and the slot being narrowed to substantially seal the unexposed film spool region from light.

132. The cartridge of claim 124, further comprising the cartridge including a first part having one of the film spool regions and a second part including the other film spool region and the bridging portion; a separable latching connection between the first and second parts of the cartridge, wherein upon the cartridge parts being latched, film can pass between the spooling regions past the bridging portion, and with the parts unlatched and separable, access to the first spool is enabled.

133. The cartridge of claim 132, further comprising a film or a canister for the film disposed in the first part of the cartridge and the film is removable from the first part to be drawn past the bridging portion to the spooling region in the second part of the cartridge.

134. The combination of claim 105, further comprising respective cooperating indexing elements on the cartridge and in the camera body positioned to be engaged as the cartridge is being installed on the camera body for positioning the cartridge at a particular location at the camera body to permit light and image to pass to the film in the cartridge.

135. A camera comprising:
a photographic film cartridge forming a dark room for accommodating a film, and
a camera body having a receptacle for removably and snugly accepting said cartridge therein,
wherein said film cartridge is provided with a sprocket for advancing said film.

136. The camera of claim 135 wherein said sprocket engages with an interlock control provided on said camera body, and is driven by said interlock control which follows a triggering activation of a shutter of said camera.

137. The camera of claim 136 wherein said sprocket is adapted to advance one frame of said film upon each of said triggering activation.

138. The camera of claim 137 wherein said sprocket comprises a receiving means for engaging with said interlock control.

139. The camera of claim 138 wherein said receiving means is a hollow shaft with a toothed inner surface engaging with a toothed shaft of said interlock control.

140. The camera of claim 139 wherein said toothed shaft of said interlock control comprises a tapered head for facilitating insertion of said toothed shaft into said hollow shaft of said sprocket.

141. The camera of claim 136 wherein said cartridge is provided with an opening which remains closed when said cartridge is removed from said receptacle, and is openable for exposing said film to a light control device to form an image on said film when said cartridge is accepted in said receptacle.

142. The camera of claim 136 wherein said camera body has a light control device for communicating an image to said film, and said cartridge comprises a light sealed housing forming said dark room but with an opening sized for exposing only one single frame of said film and positioned for exposing said single frame to said light control device when said cartridge is attached to said camera body.

143. The camera of claim 136 wherein said cartridge is provided with an opening and a door selectively movable between a first position to close said opening and a second position to open said opening, and wherein said film is, upon exposure, within a light tight container that is within said cartridge.

144. The camera of claim 136 wherein said cartridge further comprises a container inside said dark room for collecting exposed films, said container being removable from said cartridge.

145. The camera of claim 136 wherein said cartridge comprises a collection spool for collecting exposed frames of said film, and said camera body comprises a control means to drive said collection spool to collect said exposed frames upon said triggering activation of said shutter of said camera.

146. The camera of claim 145 wherein said control means comprises a driving shaft with a protrusion on its peripheral surface which is adapted to laterally abut a block inside a receptacle formed on said collection spool for accepting said driving shaft, and said driving shaft is biased toward said receptacle by a spring.

147. A film cartridge detacheably attacheable to a camera body, comprising a light sealed housing forming a dark room for accommodating a film therein, further comprising a sprocket for advancing a frame of said film each time a photo is taken.

148. The film cartridge of claim 147 wherein said sprocket comprises a hollow shaft with a toothed inner surface engageable with a toothed shaft of interlock control provided on said camera body.

149. The film cartridge of claim 148 wherein said sealed housing has an opening sized for exposing only a single frame of said film, and said film is contained in a light tight container.

150. The film cartridge of claim 148 wherein said housing is provided with an opening which remains closed with a door when said cartridge is detached from said camera body and is openable when said cartridge is attached to said camera body.

151. The film cartridge of claim 148 further comprises a body part comprising an unexposed spooling region and a collection region, and a cover part for engaging with said body part to form said light sealed dark room, and said body part has a hole at a bottom of said unexposed spooling region for receiving a spooling driver to spool said film in said unexposed region.

152. The film cartridge of claim 148 further comprises a container inside said dark room for collecting exposed films, and said container is removable from said cartridge.

153. A camera comprising:
a photographic film cartridge forming a dark room for accommodating a film, a camera body having a receptacle for removably and snugly accepting said cartridge therein, and a self-lock mechanism for holding said film cartridge inside said receptacle of said camera body, said self-lock mechanism is movable between a locking position in which said cartridge is held in said receptacle, and a release position in which said cartridge is removable from said receptacle,
wherein said self-lock mechanism comprises a holder which, in said locking position, rests against a bottom surface of said cartridge to prevent said cartridge from leaving said receptacle, and in said release position, moves away from said bottom surface of said cartridge.

154. The camera of claim 153 wherein said self-lock mechanism further comprises a lock for releasable keeping said holder in said locking position.

155. The camera of claim 154 wherein said holder is an L-shaped element including an arm portion adapted to rest on said bottom surface of said cartridge, and a leg portion kept in a slot space formed in a wall of said camera body, and wherein said lock is a resilient element kept in said slot space and integrated to said leg portion at a bulb-like end.

156. The camera of claim 155 wherein said lock comprises a release end protruding from said slot space and a barb for engaging with a stop formed on said wall of said camera body.

157. The camera of claim 156 wherein said lock is inclined to bend when said release end is being pushed toward said cartridge whereby said barb is disengaged from said stop to allow said lock, and therefore said leg portion of said holder, to move outward from said slot space.

158. The camera of claim 157 wherein said slot space is formed with a curved inner surface along which said bulb-like end of said lock moves when said lock moves outward, whereby pivoting said holder away from said cartridge.

159. The camera of claim 153 wherein said camera body has a cut away portion on a side wall for facilitating removal of said cartridge from said camera body when said self-lock mechanism is in said release position.

160. The camera of claim 153 further comprises a biasing spring for forcing said cartridge to move slightly away from said receptacle when said self-lock mechanism is in said release position.

161. The camera of claim 158, wherein said cartridge is provided with an opening which remains closed when said cartridge is removed from said receptacle, and is openable for exposing said film to a light control device to form an image on said film when said cartridge is accepted in said receptacle.

162. The camera of claim 158, wherein said camera body has a light control device for communicating an image to said film, and said cartridge comprises a light sealed housing forming said dark room but with an opening sized for exposing only one single frame of said film and positioned for exposing said single frame to said light control device when said cartridge is attached to said camera body.

163. The camera of claim 158 wherein said cartridge is provided with an opening and a door selectively movable between a first position to close said opening and a second position to open said opening, and wherein said film is, upon exposure, within a light tight container that is within said cartridge.

164. The camera of claim 158 wherein said cartridge further comprises a container inside said dark room for collecting exposed films, said container being removable from said cartridge.

165. The camera of claim 158 wherein said cartridge comprises a collection spool for collecting exposed frames of said film, and said camera body comprises a control means to drive said collection spool to collect said exposed frames upon said triggering activation of said shutter of said camera.
